(19) United States
(12) Patent Application Publication
(10) Pub. No.: US 2026/0359037 A1
(43) Pub. Date: Nov. 12, 2026

(54) VEHICLE SOFTWARE CHANGE DEVICE, VEHICLE SOFTWARE CHANGE METHOD, AND STORAGE MEDIUM THEREOF

(71) Applicant: DENSO CORPORATION, Kariya-city (JP)

(72) Inventors: Takuya KUME, Kariya-city (JP); Kazuki IZUMI, Kariya-city (JP); Atsushi BABA, Kariya-city (JP)

(21) Appl. No.: 19/712,274

(22) Filed: Jun. 18, 2026

Related U.S. Application Data
(63) Continuation of application No. PCT/JP2024/040955, filed on Nov. 19, 2024.

(30) Foreign Application Priority Data
Dec. 25, 2023 (JP) 2023-218343

(51) Int. Cl. G06F 8/65; B60W 50/14; B60W 60/00

(52) U.S. Cl. CPC G06F 8/65; B60W 50/14; B60W 60/0051

(57) ABSTRACT

A vehicle software change device performs a process related to a software change including a change of notification mode in a vehicle. The vehicle software change device includes at least one processor with a memory storing computer program code, and the at least one processor with the memory is configured to specify the software change, which changes the notification mode in each of multiple notification devices mounted on the vehicle, and conduct the software change by providing a time difference between a change timing of the notification mode in one of the multiple notification devices and a change timing of the notification mode in another one of the multiple notification devices.

### CROSS REFERENCE TO RELATED APPLICATIONS

The present application is a continuation application of International Patent Application No. PCT/JP2024/040955 filed on Nov. 19, 2024, which designated the U.S. and claims the benefit of priority from Japanese Patent Application No. 2023-218343 filed on Dec. 25, 2023. The entire disclosures of all of the above applications are incorporated herein by reference.

### TECHNICAL FIELD

The present disclosure relates to a software change including a notification mode in a vehicle participating in open road traffic.

### BACKGROUND

There has been known a device for performing change of vehicle software. The vehicle software is installed in vehicle that participates in open road traffic and has come onto the market.

### SUMMARY

According to an aspect of the present disclosure, a vehicle software change device performs a process related to a software change including a change of notification mode in a vehicle. The vehicle software change device includes at least one processor with a memory storing computer program code. The at least one processor with the memory may be configured to specify the software change, which changes the notification mode in each of multiple notification devices mounted on the vehicle, and conduct the software change by providing a time difference between a change timing of the notification mode in one of the multiple notification devices and a change timing of the notification mode in another one of the multiple notification devices.

### BRIEF DESCRIPTION OF DRAWINGS

The present disclosure will become apparent from the following detailed description made with reference to the accompanying drawings. In the drawings:

FIG. 1 is a diagram illustrating an example of a hardware configuration of a driving system or the like;

FIG. 2 is a diagram illustrating a functional configuration of the driving system;

FIG. 3 is a diagram illustrating an example of a configuration of a cockpit;

FIG. 4 is a diagram illustrating an outline of a management system;

FIG. 5 is a diagram illustrating a definition example of a change order and a time difference;

FIG. 6 is a flowchart illustrating a process related to a software change;

FIG. 7 is a diagram illustrating software switching;

FIG. 8 is a diagram illustrating switching of a display mode;

FIG. 9 is a flowchart illustrating a process in a test conduction period;

FIG. 10 is a flowchart illustrating a process related to a change in a notification mode;

FIG. 11 is a flowchart illustrating a process related to a change in a notification mode;

FIG. 12 is a diagram illustrating a change condition;

FIG. 13 is a flowchart illustrating a process in a test conduction period;

FIG. 14 is a flowchart illustrating a process in a test conduction period;

FIG. 15 is a flowchart illustrating a process related to a software change;

FIG. 16 is a flowchart illustrating a process related to a software change;

FIG. 17 is a flowchart illustrating a process related to a software change;

FIG. 18 is a diagram illustrating an example of a hardware configuration of a processing system; and

FIG. 19 is a diagram illustrating an example of a hardware configuration of the processing system.

### DETAILED DESCRIPTION

In recent years, in order to cope with a high functionality of vehicles, development of information communication technology, and the like, multiple notification devices that notify a driver and other passengers are increasingly mounted on one vehicle. However, when the software change including the notification mode is conducted on all of the multiple notification devices at the same timing, for example, there is a concern that the vehicle user such as the driver may be confused.

According to an aspect of the present disclosure, a vehicle software change device performs a process related to a software change including a change of notification mode in a vehicle. The vehicle software change device includes at least one processor with a memory storing computer program code. The at least one processor with the memory is configured to specify the software change, which changes the notification mode in each of multiple notification devices mounted on the vehicle, and conduct the software change by providing a time difference between a change timing of the notification mode in one of the multiple notification devices and a change timing of the notification mode in another one of the multiple notification devices.

According to another aspect of the present disclosure, a vehicle software change method, which is performed by at least one processor executing computer program code stored in a memory, is provided. The software change includes a change of notification mode in a vehicle. The vehicle software change method includes specifying the software change, which changes the notification mode in each of multiple notification devices mounted on the vehicle; and conducting the software change by providing a time difference between a change timing of the notification mode in one of the multiple notification devices and a change timing of the notification mode in another one of the multiple notification devices.

According to another aspect of the present disclosure, a computer-readable non-transitory storage medium stores vehicle software change program for performing a process related to a software change including a change of notification mode in a vehicle. The vehicle software change program includes instructions to be executed by at least one processor to execute: specifying the software change, which changes the notification mode in each of multiple notification devices mounted on the vehicle; and conducting the software change by providing a time difference between a change timing of the notification mode in one of the multiple notification devices and a change timing of the notification mode in another one of the multiple notification devices.

According to the above aspects, in conduction of the software change in the multiple notification devices, the change in the notification mode is distributed to different change timings. Therefore, a vehicle user such as a driver is restricted from being confused from the simultaneous change of the notification mode in all notification devices. In this way, the software change including the notification mode can be appropriately conducted.

Hereinafter, multiple embodiments will be described based on the drawings. Duplicate descriptions may be omitted by assigning the same reference numerals to the corresponding elements in each embodiment. When only a part of the configuration is described in each embodiment, the configurations of the other embodiments described above can be applied to the other parts of the configuration. In addition, configurations specified in the description of each embodiment can be combined, and especially, configurations of multiple embodiments can be partially combined even though not specified here so long as no problem occurs in the combination thereof.

In the following multiple embodiments, the contents of “Safety First for Automated Driving” Tech. Rep., 2019, by Aptiv, Audi, Baidu, BMW, Continental, Daimler, FCA, HERE, Infineon, Intel, and Volkswagen, contents of ISO 21448:2022, and contents of IEEE 2846-2022 are incorporated by reference in their entirety.

### DESCRIPTION OF TERMS

The following describes terms related to the present disclosure. This description is included in the embodiments of the present disclosure.

A road user may be a traffic participant on or adjacent to an active road for the purpose of moving from a certain place to another place.

A dynamic driving task (DDT) may be a real-time operation functionality and a real-time strategic functionality for operating a vehicle in traffic. The dynamic driving task may be all real-time operation functionalities and real-time strategic functionalities for operating the vehicle on the road.

An automated driving system (ADS) may be a batch of hardware and software capable of continuously executing the entire DDT regardless of whether the automated driving system is limited to a specific operational design domain.

ADS functionality (ADS feature) may be a design-specific functionality of the ADS in a specific ODD at a predetermined automated driving level.

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other systems using takeover/fallback states and associated use cases. The DDT fallback may be a response by the user for executing the DDT or achieving an MRC after the occurrence of a system failure related to the DDT capability or during deviation from the ODD, or a response by the ADS for achieving the MRC when placed in the same situation.

The minimal risk condition (MRC) may be a vehicle state in order to reduce the risk, when a predetermined trip cannot be completed. The minimal risk condition may be a stable stop state that the user or the ADS brings to the vehicle after the DDT fallback is executed in order to reduce the risk of an accident when the predetermined trip cannot or should not be continued.

The operational design domain (ODD) may be a specific condition which is designed such that a predetermined (automated) driving system functions. The operational design domain is an operation condition specially designed such that a predetermined ADS or a functionality thereof functions, and includes, but is not limited to, the presence or absence of requirements of environmental, geography, and time zone restrictions, and/or certain traffic/road properties.

Safety of the intended functionality (SOTIF) may be the absence of unreasonable risks due to inadequacy of the intended functionality or the implementation functionality thereof.

A driving policy may be a strategy and a rule defining a control action at a vehicle level.

A situation is a factor that can affect a behavior of a system, and may include traffic situations, weather, and the behavior of the ego-vehicle.

A scenario may be a description of the temporal relationships between several scenes in a series of scenes, including goals and values in a specific situation influenced by actions and events. The scenario may be a description of consecutive activities in time series in which a vehicle as a main object, all external environments thereof, and interactions thereof in a process of executing a specific driving task are integrated.

A safety-relevant object may be any moving or static object that may be relevant to the safety performance of the DDT.

The term “reasonably foreseeable” may mean being technically reliable and having a credible or measurable occurrence rate.

A triggering condition may be a specific condition of a scenario functioning as a trigger for a response that is a response of a subsequent system and that contributes to inability to prevent, detect, and reduce hazardous behaviors and reasonably foreseeable indirect misuse.

The minimal risk maneuver (MRM) may be a movement of the vehicle instructed by the automated driving system during the DDT fallback to achieve the MRC.

The risk acceptance criteria/criterion are/is criteria/a criterion indicating that there is no unreasonable level of risk, and may be, for example, a physical parameter defining when a specific behavior is regarded as an unsafe behavior, the maximum number of accidents per hour, the lowest level that is reasonably executable, or the like.

A proper response may be an action that is significant to avoid and ameliorate a hazardous situation in a reasonably foreseeable scenario in which other safety-relevant objects are operating within an assumption range.

The safety-related model may be representation of a safety-related aspect of the driving action based on assumptions on the reasonably foreseeable behavior of other road users. The safety-related model may be an on-board or off-board checker or an on-board or off-board safety analysis device, a mathematical model, a set of more conceptual rules, a set of scenario-based behavior, or a combination thereof.

A formal model may be a model represented in a formal representation used for system capability verification.

A safety envelope may be a set of restrictions and conditions that are designed for a (automated) driving system to operate as a target for a constraint or a control in order to maintain an operation at an acceptable risk level. The safety envelope may be a general concept that can be used to deal with all principles on which the driving policy can be based. According to this concept, an ego-vehicle operated by the (automated) driving system can have one or multiple boundaries around the ego-vehicle.

The verification may be an activity for determining that the operation of the vehicle equipped with the (automated) driving system achieves the safety of the (automated) driving system application defined in the intended environment.

The validation may be an activity for determining that an inspection object satisfies a designated requirement.

The positive risk balance may be a criterion to demonstrate that a technical solution achieves an acceptable level of residual risk.

The object and event detection and response (OEDR) may be a sub-task of the DDT including monitoring the driving environment and executing an appropriate response to such an object or event.

A response time may be a time required for the road user to sense a specific stimulus and start executing a response (braking, steering, acceleration, stopping, or the like) in a predetermined scenario.

### First Embodiment

### (Driving System)

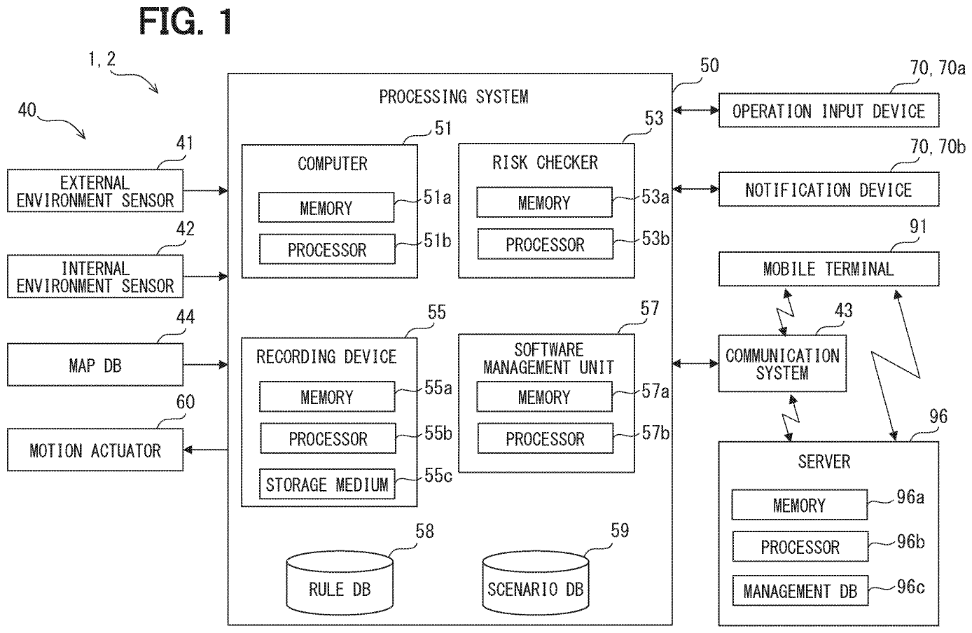

A driving system 2 of a first embodiment illustrated in FIG. 1 implements functionalities related to driving of a vehicle 1. The driving system 2 may be a vehicle system itself or may be a component forming a part of the vehicle system. A part or all of the driving system 2 is mounted on the vehicle 1. The vehicle 1 may be referred to as an ego-vehicle, a host vehicle, or the like. The vehicle 1 may be configured to communicate with another vehicle or the like directly or indirectly via communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. The automated driving may be referred to as autonomous driving by the driving system 2. Levels of the driving are classified in accordance with a range or the like of tasks executed by a human driver, among all dynamic driving tasks (DDTs). The automation level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs the entire DDT while the ADS functionality (ADS feature) is operating. Levels 3 to 5 may be classified as so-called automated driving. Systems capable of executing driving at level 3 or higher may be referred to as automated driving systems (ADS). A vehicle on which an automated driving system is mounted or a vehicle capable of executing driving at level 3 or higher may be referred to as an automated vehicle/autonomous vehicle (AV).

Level 3 indicates that driving is conditionally automated. The automated driving system at level 3 executes the DDT but does not execute the DDT fallback. That is, the DDT fallback is executed by a driver who is ready for fallback. Level 4 indicates that driving is highly automated. The automated driving system at level 4 executes the DDT and the DDT fallback. The automated driving system at level 4 can cause the driver to take over the DDT after reaching the minimal risk condition (MRC) by executing the DDT fallback or the like. The takeover of the DDT between the driving system 2 and the human driver is also referred to as authority transfer. Level 5 indicates that driving is fully automated.

The conditions for executing automated driving at levels 3 and 4 may include some or all of the conditions indicated by the operational design domain (ODD). For example, the ADS functionality may be defined within the range of ODD. The driving system 2 described in the present embodiment is a driving system capable of executing automated driving at level 3 or higher. That is, the driving system 2 may be capable of executing automated driving up to level 3, may be capable of executing automated driving up to level 4, or may be capable of executing automated driving up to level 5.

The driving system 2 provides a functionality such as automated driving to a vehicle user of the vehicle 1 who participates in open road traffic. For example, the vehicle user may be a driver in the vehicle 1. The vehicle user may be an occupant in the vehicle 1. For example, when the vehicle 1 is a personally owned vehicle (POV), the vehicle user may be an owner who owns the vehicle 1. For example, when the vehicle 1 is used for mobility as a service (MaaS), the vehicle user may be an operation administrator who manages the operation of the vehicle 1.

An architecture of the driving system 2 is selected such that a safety of the intended functionality (SOTIF) process can be implemented. For example, the architecture of the driving system 2 may be configured based on a sense-plan-act model. The sense-plan-act model includes a sense element, a plan element, and an act element, as main system elements. The sense element, the plan element, and the act element interact with one another. The sense may be replaced with perception, the plan may be replaced with determination, and the act may be replaced with control, respectively.

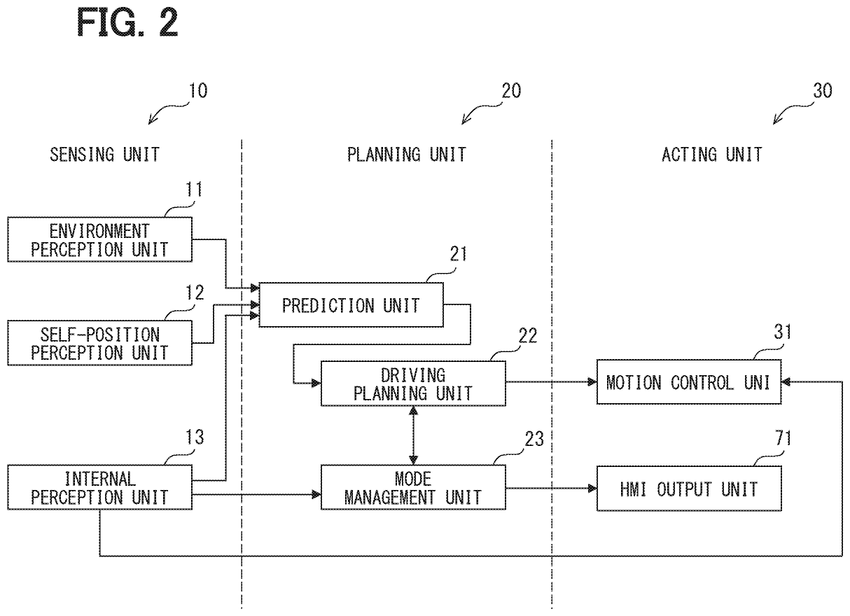

In such driving system 2, at a technical level (in other words, a technical perspective), at least multiple sensors 40 corresponding to the sensing functionality, at least one processing system 50 corresponding to the planning functionality, and multiple motion actuators 60 corresponding to the acting functionality are implemented. In the functionality level (in other words, a functional viewpoint), a sensing functionality, a planning functionality, and an acting functionality are implemented (also see FIG. 2).

Specifically, a sensing unit 10 as a processing unit for implementing the sensing functionality mainly using the multiple sensors 40, a processing system 50 that processes sense information of the multiple sensors 40, and a processing system 50 that generates an environment model based on information of the multiple sensors 40 may be constructed in the driving system 2. A planning unit 20 and a risk checking unit 26 as processing units for implementing the planning functionality mainly using the processing system 50 may be constructed in the driving system 2. An acting unit 30 as a processing unit for implementing the acting functionality mainly using multiple motion actuators 60 and at least one processing system 50 that outputs an operation signal of the multiple motion actuators 60 may be constructed in the driving system 2.

The sensing unit 10 may be implemented in a form of a sensing system serving as a subsystem that is provided to be distinguishable from the planning unit 20 and the acting unit 30. The planning unit 20 may be implemented in a form of a planning system as a subsystem that is provided to be distinguishable from the sensing unit 10 and the acting unit 30. The planning system may include the risk checking functionality. The risk checking functionality may be mounted on the driving system 2 independently of the sensing unit 10, the planning unit 20, and the acting unit 30. The acting unit 30 may be implemented in a form of an acting system serving as a subsystem that is provided to be distinguishable from the sensing unit 10 and the planning unit 20. The sensing system, the planning system, and the acting system may form independent components. The subsystem here may be replaced with a module, a unit, a device, or the like.

The sensing unit 10 serves as the sensing functionality including localization (for example, estimation of position) of a road user such as the vehicle 1 and another vehicle. The sensing unit 10 senses an external environment, an internal environment, and a vehicle state of the vehicle 1 and further senses a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control action. The acting unit 30 executes the control action derived by the planning unit 20.

### (Physical Architecture)

An example of a physical architecture of the driving system 2 will be described by using FIG. 1. The driving system 2 includes the multiple sensors 40, the multiple motion actuators 60, multiple HMI devices 70, and at least one processing system 50. These elements can communicate with each other through one or both of a wireless connection and a wired connection. These elements may be capable of communicating with each other through, for example, an in-vehicle network such as a CAN (registered trademark).

The multiple sensors 40 include one or multiple external environment sensors 41. The multiple sensors 40 may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 of a target object detection type include a camera, a light detection and ranging/laser imaging detection and ranging (LiDAR), a laser radar, a millimeter wave radar, an ultrasonic sonar, and the like. Typically, a combination of multiple types of external environment sensors 41 may be mounted to monitor directions including a front direction, a side direction, and a rear direction of the vehicle 1.

The external environment sensor 41 may detect a state of an atmosphere or a state of weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereafter, a motion physical quantity) related to a vehicle motion in the internal environment of the vehicle 1. Examples of the internal environment sensor 42 of a motion physical quantity detection type include a velocity sensor, an acceleration sensor, a gyro sensor, and the like. The internal environment sensor 42 may detect a state of an occupant in the internal environment of the vehicle 1. The internal environment sensor 42 of an occupant detection type is, for example, an actuator sensor, a sensor monitoring a vehicle user (for example, a driver) and a system thereof, a biometric sensor, a seating sensor, or an in-vehicle device sensor. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive communication signals to and from an external system (for example, a server 96) present in an external environment of the vehicle 1. A communication device of a V2X type in the communication system 43 is, for example, a dedicated short range communications (DSRC) communication device, or a cellular V2X (C-V2X) communication device. Examples of the communication with a V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of the V2X communication, including the V2I communication, may adopt an architecture defined in ISO 21217, ETSI TS 102 940-943, IEEE 1609, or the like.

The communication system 43 may transmit and receive a communication signal to and from the internal environment of the vehicle 1, for example, with a mobile terminal 91 such as a smartphone present in the vehicle. A communication device of a terminal communication type in the communication system 43 is, for example, a Bluetooth (registered trademark) device, a Wi-Fi (registered trademark) device, or an infrared communication device. When the mobile terminal 91 of the vehicle user is associated with the vehicle 1 in advance, the communication system 43 may transmit and receive a communication signal to and from the mobile terminal present in the external environment.

The map DB 44 is a database for storing map data usable in the driving system 2. The map DB 44 includes at least one type of non-transitory tangible storage medium of, for example, a semiconductor memory, a magnetic medium, or an optical medium. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high-definition map having a high level of definition mainly used for an automated driving system. The map DB 44 may include a database of a parking lot map including specific parking lot information, for example, parking space markings information, used for automated parking or parking support.

The map DB 44 appropriate to the driving system 2 acquires and stores the latest map data through, for example, communication with a map server via the communication system 43 of a V2X type. The map data is converted into two-dimensional or three-dimensional data as data indicating the external environment of the vehicle 1. The map data may include, for example, road data representing at least one type among positional coordinates, a shape, and a road surface condition of a road structure and a standard roadway. The map data may include marking data representing at least one type of, for example, a road sign, a road display, and a positional coordinate and a shape of a lane marking attached to a road. The marking data included in the map data may represent, for example, a traffic sign, an arrow marking, a lane marking, a stop line, a direction sign, a landmark beacon, a business sign, or a change in a line pattern of a road among target objects. The map data may include structure data representing at least one type of positional coordinates, a shape, and the like of a building and a traffic light facing the road, for example. The marking data included in the map data may represent, for example, a streetlight, a road edge, a reflecting plate, or a pole among the target objects.

The motion actuator 60 is capable of controlling a vehicle motion based on an input control signal. The motion actuator 60 of a driving type is a power train including, for example, at least one type among an internal combustion engine, a drive motor, and the like. The motion actuator 60 of a braking type is, for example, a brake actuator. The motion actuator 60 of a steering type is, for example, a steering wheel.

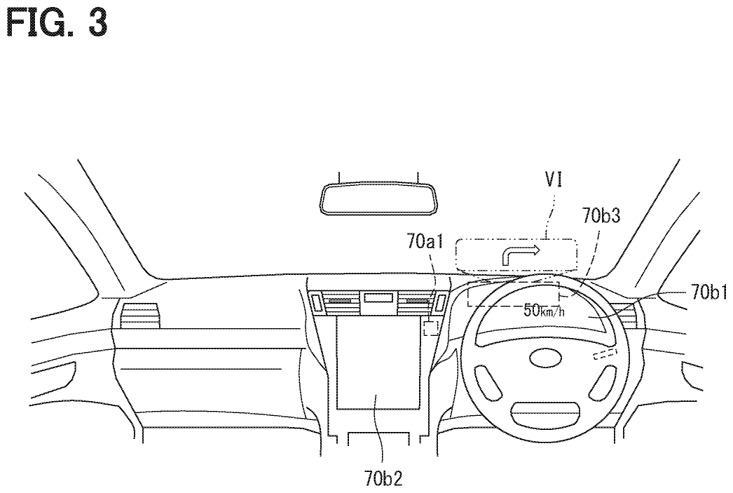

As illustrated in FIG. 3, multiple human machine interface (HMI) devices 70 may be mounted on the vehicle 1. The HMI device 70 implements a human machine interaction, which is an interaction between a user of the vehicle 1 and the driving system 2. Some of the multiple HMI devices 70, which implement an operation input functionality for the occupant, may be a part of the sensing unit 10. Some of the multiple HMI devices 70, which implement a notification functionality, may be a part of the acting unit 30. Meanwhile, the functionality implemented by the HMI device 70 may be provided as a functionality independent of the sensing functionality, the planning functionality, and the acting functionality.

The HMI device 70 may be an operation input device 70a capable of inputting an operation by the user to transmit the will or intention of the user of the vehicle 1 to the driving system 2. The HMI device 70 of an operation input type, that is, the operation input device 70a, is, for example, an accelerator pedal, a brake pedal, a shift lever, a steering wheel, a turn signal lever, a mechanical switch, and a touch panel of a navigation unit or the like. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be a notification device 70b that presents information such as visual information, auditory information, and cutaneous sensory information to the user of the vehicle 1. The HMI device 70 of the visual information presentation type, that is, the notification device 70b, is, for example, a meter display 70b1, a navigation unit, a center information display (CID) 70b2, a head-up display (HUD) 70b3, or an illumination unit.

The meter display 70b1 is, for example, a display device disposed in a driver facing portion of an instrument panel facing a driver's seat on which the driver sits. The meter display 70b1 displays information necessary for driving to the driver, focusing on the vehicle state including the velocity of the vehicle 1 and the like. The meter display 70b1 may be a graphic meter that displays all information by an image, or may be a combination meter that combines image display and analog display by a device.

The CID 70b2 is, for example, a display device disposed in a central portion of an instrument panel. The CID 70b2 has the largest display screen among in-vehicle display devices mounted on the instrument panel. The CID 70b2 can display an image not only to the driver but also to the passenger. The CID 70b2 may include a touch panel that can be touch-operated by the vehicle user, and in this case, the CID 70b2 also corresponds to the operation input device 70a.

The HUD 70b3 is a display device disposed on the instrument panel on a side opposite to the meter display 70b1 with the driver's seat being interposed therebetween, that is, on a back side of the driver facing portion. The HUD 70b3 projects an image onto a front windshield of the vehicle 1, thereby enabling the driver to display a virtual image VI that appears to be floating outside the vehicle.

Instead of the CID 70b2 and the meter display 70b1, a pillar-to-pillar display disposed to cross the left and right A-pillars may be adopted. Even in this case, the pillar-to-pillar display may be divided into several screens, each of which may be controlled in the same manner as the CID 70b2 and the meter display 70b1.

The notification device 70b of a visual information presentation type (hereinafter, referred to as a display for a passenger) mainly targeting a passenger other than the driver may be provided. For example, among the pillar-to-pillar displays, a screen disposed in a passenger seat facing portion facing a passenger seat and a display installed in a rear seat correspond to the display for a passenger.

The HMI device 70 of an auditory information presentation type is, for example, a speaker and a buzzer. The HMI device 70 of a cutaneous sensory information presentation type is, for example, a vibration unit of the steering wheel, a vibration unit of a seat of the driver, a reaction force unit of the steering wheel, a reaction force unit of the accelerator pedal, a reaction force unit of the brake pedal, and an air conditioning unit.

The HMI device 70 may implement an HMI functionality in cooperation with the mobile terminal 91 such as a smartphone by communicating with the terminal through the communication system 43. For example, as an alternative to the notification to the HMI device 70, the information of the driving system 2 may be displayed on the screen of the smartphone of the vehicle user through the communication system 43. On the other hand, the HMI device 70 may present information acquired from a smartphone to the user. For example, an operation input to the smartphone may be used as an alternative to an operation input to the HMI device 70.

The HMI device 70 may include, as the operation input device 70a, a feedback device 70a1 that receives feedback of the vehicle user. For example, the feedback device 70a1 includes a computer and a microphone, and when the feedback functionality is selected from the CID 70b2, the voice of the vehicle user is recorded using the microphone for a predetermined time (for example, 45 seconds). Accordingly, the vehicle user can feed back praise dissatisfaction, or the like to the vehicle 1 or the driving system 2. The feedback device 70a1 may transmit, through the communication system 43, the voice of the vehicle user recorded to an external system present in the external environment. The external system may be the server 96 described below. The vehicle 1 or the driving system 2 can be improved by aggregating the feedback of the vehicle user in the external system.

At least one processing system 50 is provided. For example, the processing system 50 may be an integrative processing system that executes a process related to the sensing functionality, a process related to the planning functionality, and a process related to the acting functionality in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70. The processing system 50 may be provided by an in-vehicle platform that can be generally used for an AV.

For example, the processing system 50 may include each of at least one processing unit or processor executing the process related to the sensing functionality, at least one processing unit or processor executing the process related to the planning functionality, and at least one processing unit or processor executing the process related to the acting functionality.

The processing system 50 includes a communication interface for an outside, and is connected to at least one type of elements related to the process performed by the processing system 50 among each sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may combine multiple dedicated computers 51 to implement a functionality such as the sensing functionality, the planning functionality, and the acting functionality.

For example, the dedicated computer 51 forming the processing system 50 may be an integrated ECU that integrates driving functionalities of the vehicle 1. The dedicated computer 51 forming the processing system 50 may be a determination ECU that determines a DDT. The dedicated computer 51 forming the processing system 50 may be a monitoring ECU that monitors driving of the vehicle 1. The dedicated computer 51 forming the processing system 50 may be an evaluation ECU that evaluates driving of the vehicle 1. The dedicated computer 51 forming the processing system 50 may be a navigation ECU that navigates a travel route of the vehicle 1.

The dedicated computer 51 forming the processing system 50 may be a locator ECU that estimates a position of the vehicle 1. The dedicated computer 51 forming the processing system 50 may be an image processing ECU that processes image data detected by the external environment sensor 41. The dedicated computer 51 forming the processing system 50 may be an actuator ECU that controls the motion actuator 60 of the vehicle 1. The dedicated computer 51 forming the processing system 50 may be an HMI control unit (HCU) that integrally controls the HMI devices 70. The dedicated computer 51 constituting the processing system 50 may be, for example, at least one external computer that is provided in an external center or a mobile terminal 91 that enables communication via the communication system 43.

The dedicated computer 51 forming the processing system 50 includes at least one memory 51a and at least one processor 51b. The memory 51a may be, for example, at least one type of non-transitory tangible storage medium, such as a semiconductor memory, a magnetic medium, and an optical medium, which non-temporarily stores a computer program, data, and the like that can be read by the processor 51b. For example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 forming the processing system 50 may be a system on a chip (SoC) in which the memory 51a, the processor 51b, and an interface are integrally implemented on one chip, or at least one SoC may be provided as an element of the dedicated computer 51.

The processing system 50 may include at least one database for executing the DDT. The database may include, for example, a non-transitory tangible storage medium of at least one type of a semiconductor memory, a magnetic medium, and an optical medium, and an interface for accessing the storage medium.

The database may be a scenario database (hereafter, referred to as “scenario DB”) 59. The database may be a rule database (hereinafter, rule DB) 58. At least one of the scenario DB 59 and the rule DB 58 may not be provided in the processing system 50, but may be provided independently in the driving system 2. At least one of the scenario DB 59 and the rule DB 58 may be provided in an external system present in an external environment and configured to be accessible from the processing system 50 via the communication system 43.

The scenario DB 59 has a scenario catalog in which a plurality of scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is set based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model (for example, the five principles of an RSS model). The multiple rules may include a traffic rule. The traffic rule may be a rule defined in the Road Traffic Law, or may be a rule based on national or regional customs.

The rules such as the traffic rules stored in the rule DB 58 may be positioned as the information provided from the sensing unit 10 to the planning unit 20 by the sensing functionality, similarly to the map information acquired from the map DB 44.

The processing system 50 may also include at least one recording device 55 that records at least one of the sensing information, planning information, and action information of the driving system 2. The recording device 55 may include at least one large-capacity storage medium 55c. The storage medium 55c may be at least one type of non-transitory tangible storage medium among, for example, a semiconductor memory, a magnetic medium, and an optical medium.

The storage medium 55c may be mounted on a substrate in a form that is not easily detachable or replaceable, and in this form, for example, an embedded Multi Media Card (eMMC) or the like using a flash memory may be adopted. At least one of the storage media 55c may be in a form that is detachable and replaceable with respect to the recording device 55, and in this form, for example, an SD card or the like may be adopted.

The recording device 55 may have a functionality of selecting information to be recorded from among the sensing information, the planning information, and the action information. In this case, the recording device 55 may include a dedicated computer.

The dedicated computer provided in the recording device 55 has at least one memory 55a and at least one processor 55b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 55a, the processor 55b, and an interface are integrally implemented on one chip, or at least one SoC may be provided as an element of the dedicated computer.

The recording device 55 may access the storage medium 55c, and execute recording in accordance with a data write command from each unit of the driving system 2. The recording device 55 may determine information transmitted to the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system present in the external environment, and configured to be accessible from the processing system 50 via the communication system 43.

The processing system 50 may include at least one risk checker 53. The risk checker 53 may be one aspect of on-board implementation of responsibility sensitive safety (RSS) as a safety model. The risk checker 53 may be an on-board checker for the planning functionality implemented by the dedicated computer 51. The risk checker 53 implements, by hardware independent of the planning unit 20, the risk checking unit 26 that implements the risk checking functionality.

The risk checker 53 may be configured mainly with a dedicated computer having at least one memory 53a and at least one processor 53b. The memory 53a may be, for example, at least one type of non-transitory tangible storage medium, such as a semiconductor memory, a magnetic medium, and an optical medium, which non-temporarily stores a computer program, data, and the like that can be read by the processor 53b. For example, a rewritable volatile storage medium such as a random access memory (RAM) may be provided as the memory 53a. The processor 53b includes, for example, at least one type of a central processing unit (CPU), a graphics processing unit (GPU), and a reduced instruction set computer (RISC)-CPU as a core.

The dedicated computer may be a system on a chip (SoC) in which the memory 53a, the processor 53b, and an interface are integrally implemented on one chip, or at least one SoC may be provided as an element of the dedicated computer.

As described above, the processing system 50 includes the memories 51a, 53a, and 55a that store software. The processors 51b, 53b, and 55b are configured to implement automated driving by operating software so that authority transfer can be performed between the system itself and the user. The software here may include the computer program itself used in the driving system 2. The software here may include an algorithm in the computer program used in the driving system 2. The software here may include parameters in the computer program used in the driving system 2. The software here may include a trained model that may be referred to as AI, which is implemented by, for example, a neural network used in the driving system 2. The software may include data stored in a database referred to in the processing system 50, data stored in the map DB 44, and the like. One piece of software may correspond to one application, may correspond to multiple applications, may be a part of one application, or may be software commonly used by a plurality of applications.

The processing system 50 may include at least one software management unit 57. The software management unit 57 implements a software management functionality. The software management unit 57 may be referred to as a vehicle software management device or a vehicle software change device.

The software management unit 57 manages various software used in the processing system 50, such as the computer 51, the risk checker 53, the recording device 55, the rule DB 58, and the scenario DB 59. The software management unit 57 may further manage software used in the driving system 2 outside the processing system 50. For example, the software management unit 57 may manage data stored in the map DB 44, software used for a drawing process by the notification device 70b, software used for a communication process by the communication system 43, and the like.

The software management may include software version management, a download process and installation process, an uninstallation process, and the like. The software management may include a software test.

In order to implement a software management functionality, the software management unit 57 may be mainly configured with a dedicated computer having at least one memory 57a and at least one processor 57b. The memory 57a may be, for example, at least one type of non-transitory tangible storage medium, such as a semiconductor memory, a magnetic medium, and an optical medium, which non-temporarily stores a computer program, data, and the like that can be read by the processor 57b. For example, a rewritable volatile storage medium such as a random access memory (RAM) may be provided as the memory 57a. The processor 57b includes, for example, at least one type of a central processing unit (CPU), a graphics processing unit (GPU), and a reduced instruction set computer (RISC)-CPU as a core.

The dedicated computer may be a system on a chip (SoC) in which the memory 57a, the processor 57b, and an interface are integrally implemented on one chip, or at least one SoC may be provided as an element of the dedicated computer.

The above-described architecture is merely an example, and various configurations can be adopted as the hardware configuration of the driving system 2.

### (Logical Architecture in Automated Driving)

Next, an example of a logical architecture of the driving system 2 will be described with reference to FIG. 2. The description here will focus on a process performed by a computer program executed during automated driving at the level 3 or higher. The sensing unit 10 may include an environment perception unit 11, a self-position perception unit 12, and an internal perception unit 13 as processing units for implementing, by executing a computer program by the processor 51b, sub-functionalities obtained by further classifying the sensing functionalities.

The environment perception unit 11 individually processes information (referred to as sensor data in some cases) on an external environment acquired from each sensor 40 and implements a functionality of perceiving the external environment including a target object, other road users, and the like. The environment perception unit 11 processes sensor data detected by each external environment sensor 41 individually. The sensor data may be sensor data provided from, for example, a millimeter wave radar, a sonar, or a LiDAR. The environment perception unit 11 may generate relative position data including a direction, a size, and a distance of an object with respect to the vehicle 1, from raw data detected by the external environment sensor 41.

The sensor data may be, for example, image data provided from a camera, a LiDAR, or the like. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

The environment perception unit 11 processes information acquired through a V2X functionality of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 conducts localization of the vehicle 1. The self-position perception unit 12 acquires global position data of the vehicle 1 from the communication system 43 (for example, a GNSS receiver). In addition, the self-position perception unit 12 may acquire position information on the target object extracted by the environment perception unit 11. The self-position perception unit 12 acquires map information from the map DB 44. The self-position perception unit 12 integrates these pieces of information to estimate a position of the vehicle 1 on a map.

The internal perception unit 13 implements a functionality of perceiving a vehicle state by processing sensor data detected by each internal environment sensor 42. The vehicle state may include a state of a motion physical quantity of the vehicle 1 detected by a velocity sensor, an acceleration sensor, a gyro sensor, or the like. The vehicle state may include at least one type of a state of a user, an operation state of the user with respect to the motion actuator 60, and a switching state of the HMI devices 70.

The planning unit 20 may include a prediction unit 21, a driving planning unit 22, and a mode management unit 23 as processing units for implementing, by executing a computer program by the processors 51b and 53b, sub-functionalities obtained by further classifying the planning functionalities.

The prediction unit 21 acquires external environment information perceived by the environment perception unit 11 and the self-position perception unit 12, the vehicle state perceived by the internal perception unit 13, and the like. The prediction unit 21 may interpret an environment based on the acquired information, and estimate the current situation in which the vehicle 1 is located. The situation here may be an operational situation, or may include an operational situation.

The prediction unit 21 may interpret the environment and predict actions of objects such as other road users. The object here may be a safety-relevant object. The prediction of the action here may include at least one of prediction of a velocity of the object, prediction of an acceleration of the object, and prediction of a trajectory of the object. The prediction of the act may be executed based on a reasonably foreseeable assumption. The prediction unit 21 may estimate an intention of the user, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and user intention estimation information provided by the prediction unit 21, functional constraint information provided by the mode management unit 23, and the like.

The driving planning unit 22 implements a route planning functionality, a behavior planning functionality, and a trajectory planning functionality. The route planning functionality is a functionality of planning at least one of a route to a destination and a lane plan at a middle distance based on the estimation information of the position of the vehicle 1 on the map. The route planning functionality may further include a functionality of determining at least one request of a lane changing request and a deceleration request, based on the lane plan at the middle distance. The route planning functionality may be a mission/route planning functionality in a strategic function, or may be a functionality of outputting a mission plan and a route plan.

The behavior planning functionality is a functionality of planning a behavior of the vehicle 1, based on at least one of the route to the destination and the lane plan at the middle distance planned by the route planning functionality, the lane changing request and the deceleration request, the prediction information and the user intention estimation information provided by the prediction unit 21, and the functional constraint information provided by the mode management unit 23. The behavior planning functionality may include a functionality of generating a condition related to a state transition of the vehicle 1. The condition related to the state transition of the vehicle 1 may correspond to a triggering condition. The condition related to the state transition may include a fallback condition for executing the DDT fallback.

The behavior planning functionality may include a functionality of determining a state transition of an application that implements a DDT, and further include a functionality of determining a state transition of a driving action, based on the condition. Accordingly, when the driving planning unit 22 plans the execution of the DDT fallback, and this does not involve authority transfer, the driving planning unit 22 may further execute a minimal risk maneuver (MRM) together with a motion control unit 31 to shift the vehicle 1 to the minimal risk condition. The plan of the MRM may be implemented by a behavior planning functionality or may be implemented by a trajectory planning functionality.

The behavior planning functionality may include a functionality of determining a constraint related to a path of the vehicle 1 in a longitudinal direction and a constraint related to the path of the vehicle 1 in a lateral direction, based on information on these state transitions. The behavior planning functionality may be a strategic behavior plan in a DDT functionality, or may output a strategic behavior.

The trajectory planning functionality is a functionality of planning a travel trajectory of the vehicle 1, based on the determination information provided by the prediction unit 21, the constraint related to the path of the vehicle 1 in the longitudinal direction, and the constraint related to the path of the vehicle 1 in the lateral direction. The trajectory planning functionality may include a functionality of generating a path plan. The path plan may include a velocity plan, or the velocity plan may be generated as a plan independent of the path plan. The trajectory planning functionality may include a functionality of generating multiple path plans and selecting an optimal path plan from the multiple path plans, or a functionality of switching between the path plans. The trajectory planning functionality may further include a functionality of generating backup data of the generated path plan. The trajectory planning functionality may be a trajectory planning functionality in the DDT functionality, or may output a trajectory plan.

The mode management unit 23 monitors the driving system 2, and sets a constraint on a functionality related to driving. The mode management unit 23 may manage a mode of automated driving, for example, a state of the automation level. The management of the automation level may include switching between manual driving and automated driving, that is, authority transfer between the user and the driving system 2, that is, management of takeover of driving. The mode management unit 23 may monitor a state of a subsystem related to the driving system 2, and determine a defect of the system (for example, an error, an unstable operation state, a system failure, or a failure). The mode management unit 23 may determine a mode based on the intention of the user, based on the user intention estimation information generated by the internal perception unit 13. The mode management unit 23 may set a constraint on a functionality related to driving, based on at least one of a determination result of the defect of the system, a determination result of the mode, and further, the vehicle state provided by the internal perception unit 13, a sensor abnormality (or sensor failure) signal output from the sensor 40, state transition information of the application and the trajectory plan provided by the driving planning unit 22, and the like.

The mode management unit 23 may have a functionality of determining the constraint related to the path of the vehicle 1 in the longitudinal direction and the constraint related to the path of the vehicle 1 in the lateral direction in an integrated manner, in addition to the functional constraint related to driving. In this case, the driving planning unit 22 plans a behavior and plans a trajectory, in accordance with the constraint determined by the mode management unit 23.

When the automation level is switched to level 2 or lower, the mode management unit 23 may control an enabled state of a driving assistance application according to the automation level.

When the risk checking functionality is implemented as a part of the planning unit 20, the risk checking functionality may be implemented as a part of the functionalities implemented by the prediction unit 21, the driving planning unit 22, and the mode management unit 23.

The risk checking functionality is a functionality of acquiring an environment model, sensor data, and the like from the sensing unit 10, evaluating a risk according to these pieces of information, and outputting a response according to the risk to the acting unit 30 or the driving planning unit 22. This series of functionalities or processes may be referred to as risk checking or risk monitoring.

More specifically, with the risk checking functionality, the situation is output based on the information acquired from the sensing unit 10. With the risk checking functionality, whether this situation is a safe situation or a hazardous situation is checked. The checking may include checking of an estimated result of a collision risk between the vehicle 1 and the surrounding object. In this checking, an index such as a collision probability can be used in consideration of uncertainty. The risk checking functionality may determine whether there is a hazardous situation by comparing an acceptable threshold of the collision risk with the estimated value of the collision risk. The threshold of the acceptable threshold of the collision risk may be set in advance based on risk acceptance criteria/criterion described in detail below.

The risk checking functionality derives a proper response based on the checking result. The proper response may be provided to the acting unit 30 or the driving planning unit 22 only when the situation is determined to be a hazardous situation. The proper response may be a restriction of a control command of the motion actuator 60. The proper response may be a response to return the vehicle 1 to a safe state.

The risk checking functionality is implemented by implementing a safety model. The safety model may be referred to as a safety-related model. The safety model may be a formal model. As the safety model, for example, the RSS model may be adopted. Meanwhile, another model such as an SFF model, a more generalized model, or a composite model obtained by combining multiple models may also be adopted. The SFF is a safety force field. The safety model monitors the risk of the vehicle 1 based on the driving policy. In other words, it can be said that the monitoring of the risk is monitoring of the driving policy.

In the RSS model, for example, a safe distance in a longitudinal direction and a safe distance in a lateral direction with respect to other road users are used as indexes used for checking the collision risk. The safe distance is an example of a geometric approach such as a safety envelope.

The acting unit 30 may include the motion control unit 31 and an HMI output unit 71 as processing units for implementing, by executing a computer program by the processor 51b, sub-functionalities obtained by further classifying the action functionalities. The motion control unit 31 controls a motion of the vehicle 1, based on the trajectory plan (for example, the path plan and the velocity plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state perceived by the sensing unit 10 (particularly, the internal perception unit 13), for example, at least one of a current velocity, a current acceleration, and a current yaw rate of the vehicle 1 from the sensing unit 10, and reflecting the vehicle state on the motion control of the vehicle 1.

The HMI output unit 71 outputs information on an HMI, based on at least one of the prediction information and the user intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction and control a notification functionality of the HMI devices 70. The HMI output unit 71 may generate a control request for a wiper, a sensor cleaning device, a headlight, and an air conditioner based on the management state of the vehicle interaction, and control these devices.

### (Test in Open Road Traffic)

It is required to execute a verification and validation (V&V) process on the driving system 2 described above. The V&V here may be V&V for a functionality intended by the software used in the driving system 2 or V&V for SOTIF. A scenario that the vehicle 1 may encounter can be classified into a known hazardous scenario, a known non-hazardous scenario, an unknown hazardous scenario, and an unknown non-hazardous scenario. The V&V process may be a process that reduces risks of a known hazardous scenario and an unknown hazardous scenario among these scenarios.

In the V&V of the driving system 2, there are verification for satisfying a safety requirement of each technical level and verification for safe integration of elements. The verification for satisfying the safety requirement of each technical level may include evaluation of at least one of the following functionalities and abilities, preferably all of the functionalities and abilities. The verification may include evaluation of other functionalities and abilities.

For example, an evaluation target for the sensing unit 10 is a functionality of the sensor 40 or an external data source (for example, a map data source), a functionality of a sensor algorithm that models an environment, and reliability of the infrastructure and the communication system 43.

For example, the evaluation target related to the planning unit 20 is the capability of the determination algorithm. The ability of the determination algorithm is, for example, an ability of safely handling a potential lack of functionality, and an ability of making a proper determination according to an environment model, a driving policy, a current destination, and the like. For example, the evaluation targets related to the planning unit 20 include one of the absence of unreasonable risks due to hazardous behaviors of the intended functionality, the functionality of the system to safely handle ODD use cases, a robust capability of execution of the entire ODD driving policy, suitability for DDT fallback, and suitability for minimal risk conditions.

For example, the evaluation target may include not only the nominal capability of the system or the functionality but also the robust capability. The robust capability of the system or the functionality is a robust capability of a system under adverse environmental conditions affected by various disturbances, suitability of a system operation under known triggering conditions, sensitivity of an intended functionality, an ability to monitor various scenarios, or the like.

The V&V may be executed with a goal of achieving a positive risk balance by the automated driving executed by the driving system 2. It can be said that the positive risk balance is a main measure of a logically acceptable risk level.

More specifically, the V&V may be executed with a goal of achieving risk acceptance criteria/criterion that can be set based on the positive risk balance. The quantitative criterion of the risk acceptance criteria/criterion is, for example, a probability of occurrence of harm falling below a threshold. The risk acceptance criteria/criterion may be set by, for example, a combination of a statistical approach such as traffic accident statistics approach and an approach based on a scenario.

When software related to at least one of a behavior plan and a trajectory plan by the driving planning unit 22 is verified or tested, it is necessary to confirm that the driving system 2 performs at least a safer behavior than a competent and careful driver or an experienced and attentive driver. When software is tested in a virtual environment, for example, a verification method based on a software-in-the-loop (SiL) may be conducted using a reference data set including a scenario stored in a scenario DB.

When software related to mode management by the mode management unit 23 is verified or tested, in particular, the verification or test related to the determination of the ODD and the management of an operating state and a non-operating state may be conducted by SiL, may be conducted by a hardware-in-the-loop (HiL), or may be conducted by both.

When the software related to the HMI by the HMI output unit 71 or the like is verified or tested, the verification or test may be conducted by the HiL and a driver-in-the-loop (DiL). The DiL test may be performed on a vehicle user such as a driver who has no previous experience or knowledge about the driving system 2 and is unfamiliar with driving such as automated driving. A test of the software related to the HMI includes a test of a notification mode.

As described above, in the verification or test of the software in the driving system 2, a verification method such as the SiL, the HiL, and the DiL may be selected according to the target and purpose of the verification or test. The loop used for the SiL, the HiL, and the DiL may be an opened loop or a closed loop.

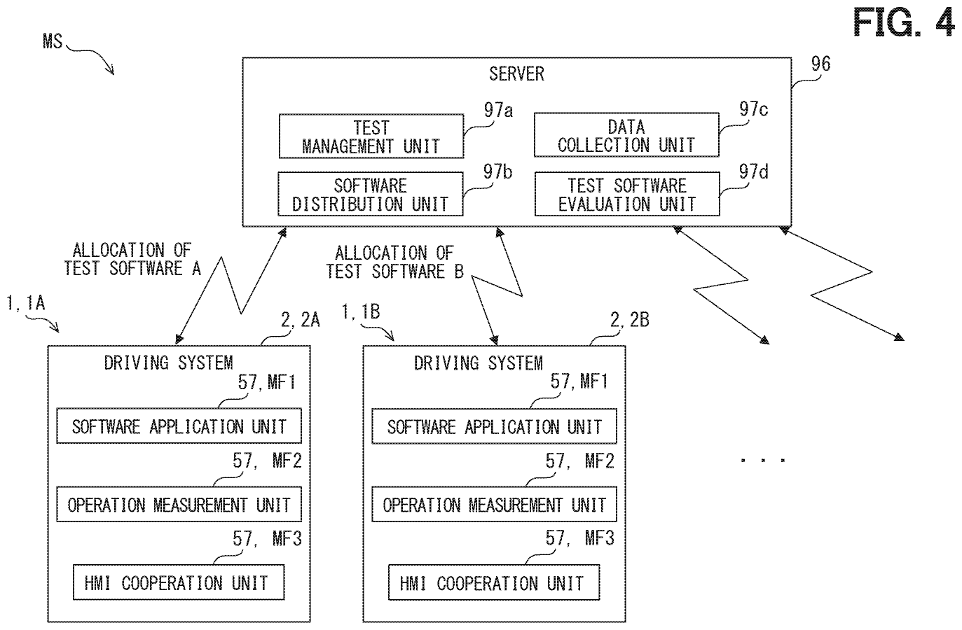

In order to manage an unacceptable risk and improve the driving system 2, it is preferable that there is a strong management system MS for the driving system 2 of the vehicle 1 that participates in open road traffic after being shipped to the market. For example, a management system MS illustrated in FIG. 4 may execute a change in the software for a vehicle population by over-the-air (OTA). The management system MS includes the vehicle population including multiple vehicles 1A, 1B, . . . , and the server 96. The vehicles 1A and 1B managed by the management system MS may have the same configuration as the vehicle 1 including the driving system 2 described above, and some of the hardware specifications such as the vehicle type and the vehicle model may be different from each other as long as there is compatibility in the software specifications at least.

In the test in the change process, data collected while each of the vehicles 1A and 1B belonging to the vehicle population is traveling on an open road may be used. In the test in the change process, an index related to safety may be used. The result of the validation using the index related to safety may not be used only to determine whether the test software is applicable. For example, the result may be used to set the ODD itself or to set parameter restrictions by the ODD. The setting here may include a specification change by software update.

In the following description, software used for a temporary test may be referred to as test software, and software used formally (permanently) may be referred to as formal software. The permanent application here may mean application until the next update of the formal software.

The test by the management system MS is not limited to only the software update, and may be conducted to improve the environment in which the driving system 2 is used. That is, the result of the test may be fed back to city planning. For example, as a result of the test, a road shape such as an intersection or a merging point may be changed to a shape with higher safety. For example, as a result of the test, the control of the traffic signal at an intersection or the like may be changed to the control in which an occurrence frequency of traffic congestion decreases.

The index related to safety may be a safety metric of the automated driving system. The safety metric may mean a scale that can be quantified based on collision rates. Examples of the safety metric include the severity and frequency of collision, the severity and frequency of citable offences, the distances in the longitudinal direction and the lateral direction, the accelerations in the longitudinal direction and the lateral direction, the jerk in the longitudinal direction and the lateral direction, the OEDR response time, and the like. The severity of the collision may be evaluated in six stages using, for example, an abbreviated injury scale (AIS). The distances in the longitudinal direction and the lateral direction are indexes related to maintenance of a safety envelope or a safety distance.

The evaluation of an index or the like related to safety may be a human evaluation. The human here may be a vehicle user of a test target vehicle. The human here may be a vehicle user unfamiliar with automated driving. In the test with the DiL, the evaluation index may be an evaluation input by a driver who is a vehicle user through the operation input device 70a (for example, the feedback device 70a1) of the test target vehicle, or may be an evaluation input through the mobile terminal 91 owned by the driver. The human here may be another VRU such as a pedestrian who encounters the test target vehicle. In this case, the evaluation may be an evaluation transmitted to the driving systems 2A and 2B of the vehicles 1A and 1B or the server 96 by another VRU who feels that the test target vehicle is hazardous using the mobile terminal 91 or the like owned by the VRU.

### (Configuration Example of Server in Management System)

As illustrated in FIGS. 1 and 4, the server 96 is placed in an external environment with respect to the vehicles 1A and 1B. The server 96 is communicably connected to the vehicles 1A and 1B by, for example, V2X communication via a communication infrastructure. The server 96 may be connected to, for example, an operation terminal operated by a human operator, and may form a remote management center that manages the vehicle population together with the operation terminal.

As illustrated in FIG. 1, the server 96 may be mainly implemented by a dedicated computer including at least one memory 96a and at least one processor 96b. The memory 96a may be, for example, at least one type of non-transitory tangible storage medium, such as a semiconductor memory, a magnetic medium, and an optical medium, which non-temporarily stores a computer program, data, and the like that can be read by the processor 96b. For example, a rewritable volatile storage medium such as a random access memory (RAM) may be provided as the memory 96a. The processor 96b includes, for example, at least one type of a central processing unit (CPU), a graphics processing unit (GPU), and a reduced instruction set computer (RISC)-CPU as a core.

The dedicated computer may be a system on a chip (SoC) in which the memory 96a, the processor 96b, and an interface are integrally implemented on one chip, or at least one SoC may be provided as an element of the dedicated computer.

The server 96 may further include a management database (hereafter, the management DB) 96c. The management DB 96c may store information for specifying the vehicles 1A and 1B to be managed by the management system MS. The management DB 96c may store information on specifications of the vehicles 1A and 1B. The management DB 96c may store various types of information collected from the vehicles 1A and 1B. The various types of information may include information for executing an evaluation in a test to be described below. The various types of information may include information on the software application situation of each of the vehicles 1A and 1B participating in the test.

The server 96 implements a software improvement functionality based on the V&V process preferable for the driving system 2. As illustrated in FIG. 4, the server 96 may include the test management unit 97a, the software distribution unit 97b, the data collection unit 97c, and the test software evaluation unit 97d as processing units for implementing the functionality by the processor 96b executing a computer program.

The test management unit 97a manages a test using the vehicle population. One type of test software may be prepared as an improved version of software (hereafter, referred to as conventional software) being applied to the vehicle population, and the test may be conducted. When two types of test software are prepared and the two types of test software are compared with each other, this test is referred to as an AB test. The multiple pieces of test software may be three or more types of software that have similar functionalities and can be compared with one another.

In the following, as a typical example of the AB test, an example in which one of multiple pieces of test software is allocated to one test target vehicle will be mainly described. On the other hand, various methods can be adopted as a test method, and for example, the AB test can be conducted by allocating multiple pieces of test software to one test target vehicle.

The test software is provided by, for example, a human administrator (hereafter, a test administrator) of the server 96. In this case, the test is conducted for the purpose of selecting the optimum software from the software as a release candidate. On the other hand, when the test is conducted to optimize the parameters used for the computer program, the test software may be software automatically generated by the test management unit 97a. For example, the test software may be automatically generated by changing parameters such as a determination threshold, an upper limit, a lower limit, a standby time, a display time, and a display size of an existing program.

The test management unit 97a manages the scale of the test and the period of the test. The scale and the period may be set to values input to the server 96 by the test administrator, or may be automatically set by the test management unit 97a. The test management unit 97a determines, based on the scale and the period, a test target vehicle suitable for conducting the test from the vehicles 1A and 1B belonging to the vehicle population. When the number of vehicles incorporated in the management system MS is smaller than the optimum scale for conducting the test, all the vehicles 1A and 1B belonging to the vehicle population may be designated as the test target vehicles.

The test management unit 97a allocates one of the multiple pieces of test software to the test target vehicle among the vehicles 1A and 1B belonging to the vehicle population. In the AB test for comparing test software A and test software B, for example, half of the test target vehicles test the test software A, and the remaining half of the vehicles test the test software B. The test management unit 97a may randomly allocate the test software to the vehicles 1A and 1B using a pseudo-random number. The test management unit 97a may refer to vehicle information stored in the management DB 96c and execute the allocation of the test software so as to reduce the bias of the condition between the groups for testing the test software.

The test management unit 97a may restrict the test conduction content. For example, the test management unit 97a may limit the test conduction area to a specific country or region. The test management unit 97a may restrict a time zone in which the test is conducted to, for example, only a daytime time zone.

The test management unit 97a sets at least one evaluation index for evaluating the test software. The evaluation index may be set, based on the functionalities and properties of the test software or the intention of the test, to an index determined by the input operation of the test administrator to the server 96. Alternatively, the evaluation index may be set by the test management unit 97a based on the functionalities and properties of the test software. The evaluation index may include an index related to safety.

The test management unit 97a may manage at least one of a method of acquiring consent of the vehicle user for applying the test software in each test target vehicle and consent content. The test management unit 97a may leave the management of at least one of the consent acquisition method and the consent content entirely to the driving systems 2A and 2B of each test target vehicle.

The software distribution unit 97b distributes the test software to the driving system 2 of the test target vehicle based on the allocation of the test software set by the test management unit 97a. Information on the planning of the test may be distributed together with the distribution of the test software. The information on the planning of the test includes information on a period and an evaluation index of the test, and may further include information such as a scale of the test. Accordingly, the test software distributed by each of the driving systems 2A and 2B is temporarily applied, and the test is started.

The data collection unit 97c collects information on an operation of the test software or an operation result thereof as probe data from each of the driving systems 2A and 2B to which the test software is temporarily applied. The information to be collected may include at least one of an index itself related to safety and information for deriving the index related to safety. The data collection unit 97c accumulates the data sequentially collected from the vehicles 1A and 1B in the management DB 96c.

The test software evaluation unit 97d compares multiple pieces of test software. The test software evaluation unit 97d compares the evaluation indexes, which are set by the test management unit 97a, between pieces of test software. When there are multiple evaluation indexes, the test software evaluation unit 97d compares each of evaluation indexes between pieces of test software.

Specifically, the test software evaluation unit 97d statistically processes the data from the vehicles 1A and 1B accumulated in the management DB 96c. For example, when the evaluation index can be expressed by a ratio such as an occurrence rate, the test software evaluation unit 97d calculates an occurrence rate per vehicle and/or per unit time from the occurrence frequency in the data from the vehicles 1A and 1B.

In the evaluation using the safety metric as the evaluation index, it is preferable to consider severity potential. In the case of evaluating the severity and frequency of a collision for the test software, even if the test software is temporarily applied to multiple vehicles 1A and 1B, it is difficult to statistically evaluate the severity and frequency of a collision when there are few cases in which a collision actually occurs. Therefore, the test software evaluation unit 97d may estimate a rate of serious collisions having a high severity from the occurrence rate of proper precursor events such as a near collision and a collision with a low severity.

The distribution and sensitivity of the collision type may be different between an automated driving system and a human driver. Therefore, in the statistical evaluation of the safety metric for the test software, the data collection and evaluation may be performed after the vehicle 1 to which the test software is applied is classified into an automated driving vehicle at level 3 or higher and the vehicle driven by a human user.

The test software evaluation unit 97d may have a functionality of selecting one piece of optimum test software from multiple pieces of test software. The optimum test software may be test software with the highest safety. The test management unit 97a may determine the test software selected by the test software evaluation unit 97d as formal software to be formally adopted.

When the multiple pieces of test software are an improved version of conventional software that is currently formally applied to each of the vehicles 1A and 1B, the test software evaluation unit 97d may execute a relative evaluation of the selected test software relative to the conventional software. The test software evaluation unit 97d may determine that the selected test software does not have higher capability than the conventional software. In this case, the test management unit 97a may exclude all of the multiple pieces of test software from formal software to be formally adopted.

On the other hand, the test software evaluation unit 97d may not have a functionality of selecting the optimum test software. In this case, the test management unit 97a presents a comparison result of an evaluation index to the test administrator through the HMI of the server 96, and receives an input operation of the selection result of the formal software to be formally adopted by the test administrator. In accordance with this input operation, the test management unit 97a determines the formal software.

The software distribution unit 97b may distribute the formal software to each of the vehicles 1A and 1B belonging to the vehicle population based on the determination of the formal software. The distribution destination vehicle may include a vehicle that belongs to the vehicle population and is not the test target vehicle. The software distribution unit 97b may request another management system to adopt the selected software or recommend the selected software to the other management system.

### (Configuration Example of Software Management Unit)

The vehicles 1A and 1B belonging to the vehicle population are equipped with individual driving systems 2A and 2B, respectively. The driving systems 2A and 2B implement a software management functionality in addition to the perception functionality, the planning functionality, and the acting functionality. The driving systems 2A and 2B may each include a software application unit MF1, an operation measurement unit MF2, and an HMI cooperation unit MF3 as processing units for implementing functionalities by the processor 57b of the software management unit 57 executing a computer program.

The software application unit MF1 manages application of software implemented in the corresponding driving systems 2A and 2B. The application of the software here may include download and installation of the software, that is, standby-ready for making the software usable. The management of application of software may include defense against an external attack that exploits security vulnerability, management of privacy in software, and management of software update. The update management may include version management of software.

The software whose application is managed by the software application unit MF1 may include test software. When the vehicles 1A and 1B are selected as test targets, the software application unit MF1 temporarily applies the test software downloaded from the server 96 to the driving systems 2A and 2B, and starts verification of the test software.

The software whose application is managed by the software application unit MF1 may include formal software. The software application unit MF1 may permanently apply the formal software selected as a result of the test to the driving systems 2A and 2B. Alternatively, the software application unit MF1 may update the conventional software to the formal software selected as a result of the test.

The operation measurement unit MF2 measures an operation result of the temporarily applied test software. The measurement target is at least one of an evaluation index designated from the server 96 side and data necessary for calculation of the evaluation index. The measurement of the operation result may be constantly conducted according to the properties of the evaluation index, or may be conducted only in a predetermined case based on a preset trigger.

The operation measurement unit MF2 transmits test results obtained by the measurement to the server 96. The results of the test may be sequentially transmitted in the progress of the test, or may be collectively transmitted at the end of the test period. The results of the test include at least one of test software application information to the driving systems 2A and 2B by the software application unit MF1 and measurement information measured by the operation measurement unit MF2. The test software application information may include a date and time and a period when the test software is applied to the driving systems 2A and 2B, a method of applying the test software to the driving systems 2A and 2B, and the like. The software application method is, for example, information indicating that test software has been installed in hardware constituting a redundant system, which is different from main hardware, or information indicating that test software has been installed using a shadow-mode mechanism. The measurement information is information on the measurement target described above.

The operation measurement unit MF2 may record the results of the test in the storage medium 55c. A transmission log to the server 96 may be recorded in the storage medium 55c together with the results of the test.

As described above, the operation measurement unit MF2 selects an index or data to be measured and an acquisition source from which the index or data is acquired, that is, a measurement target, based on the information of the evaluation index received from the server 96. Then, the operation measurement unit MF2 generates the measured index or data in the form of measurement information according to a preset format. This format may be designated from the server 96 in the information of the evaluation index. The generated measurement information can be transmitted to the server 96 as probe data and recorded in the storage medium 55c as described above.

The HMI cooperation unit MF3 cooperates with the HMI device 70 to implement a functionality of acquiring the consent described above, a functionality of executing a notification related to software management, and a functionality of receiving feedback from the vehicle user. As a functionality of executing a notification related to software management, the HMI cooperation unit MF3 controls the HMI device 70 based on a request from the software application unit MF1 so as to minimize confusion of a vehicle user such as an occupant when software is changed, for example, when test software is applied. The software change here may be a software change including a change in the notification mode or may be a software change not including a change in the notification mode. However, the software change including a change in the notification mode will be described in detail below. The software change may be a change in one computer program or a change in multiple computer programs related to each other.

### (Software Change Including Change in Notification Mode)

When a software change such as temporary application of test software or application of formal software is required, the software application unit MF1 grasps a range of the change and a device that the change will affect. The information on the range of the change and the device that the change will affect may be provided together with the download of the software from the software distribution unit 97b when the software after the change is distributed from the server 96. On the other hand, the range of the change and the device that the change will affect may be determined based on the software downloaded by the software application unit MF1 on the vehicle 1 side.

The software application unit MF1 determines whether the software change involves change in the notification mode. When the software change includes the change in the notification mode, the software application unit MF1 further determines whether the change in the notification mode affects the multiple notification devices 70b of the same vehicle 1. In this way, the software change including the change in the notification mode of the multiple notification devices 70b is specified.

The change in the notification mode includes, for example, at least one of a change in a visual information mode (display mode), a change in an auditory information mode (sound mode), a change in a cutaneous sensory information mode, and the like. Examples of the change in the visual information mode include a change in a display content, a change in a display layout, a change in a display font, a change in a timing for outputting navigation such as route guidance to the driver, and a change in appearance, texture, and the like. Examples of the change in the auditory information mode include a change in the type and volume of an alarm sound, a change in a generation timing of the alarm sound, a change in the type and volume of an operation sound of the HMI device 70 by the driver, a change in a route guidance voice from a female voice to a male voice, and a change in a BGM for relaxing the vehicle user. Examples of the change in the cutaneous sensory information mode include a change in a vibration pattern, a vibration frequency, a magnitude, and a generation timing of the vibration of the steering wheel accompanying the alarm.

When the change in the notification mode affects the multiple notification devices 70b of the same vehicle 1, the software application unit MF1 determines to provide a time difference in the change timings of the notification mode among the multiple notification devices 70b. The software application unit MF1 defines an order of changing the notification mode for the multiple notification devices 70b.

The software application unit MF1 may be configured to adopt, as the order of changing the notification mode, an order defined as a specification in advance at a design stage based on a mounting situation of the notification devices 70b in the vehicle 1. On the other hand, the software application unit MF1 may be configured to flexibly set the order based on the specific change content. When the order is flexibly set, a rule for setting the order may be given in advance, and the order may be determined based on the rule. Alternatively, the rule is not present, and the order may be determined using a trained model implemented by a neural network.

The software application unit MF1 defines a specific time difference in the change timings between the multiple notification devices 70b. All the time differences may be set to a common value set in advance. On the other hand, the time difference may be individually set according to the specific change content and the characteristics of the notification device 70b. For example, when the quantity of information changed for a certain notification device 70b is larger than the quantity of information set in advance, the software application unit MF1 may set the time difference with the notification device 70b, which is defined as the order before and after the change, to be larger than the standard time difference.

Alternatively, the time difference may be set according to a load of the started test on the vehicle user. For example, when the test is conducted on a driver who is unfamiliar with driving, the load of the test on the driver is large. Therefore, in the software change for starting the test, the time difference may be set to be larger than a standard time difference.

The change timing may be set as an absolute timing of each of the notification devices 70b. On the other hand, when the time difference as the relative timing is set as described above, it is easy to avoid a situation in which the notification modes of the multiple notification devices 70b are changed substantially at the same time when the change in some notification devices 70b is delayed at the timing set due to some event or abnormality.

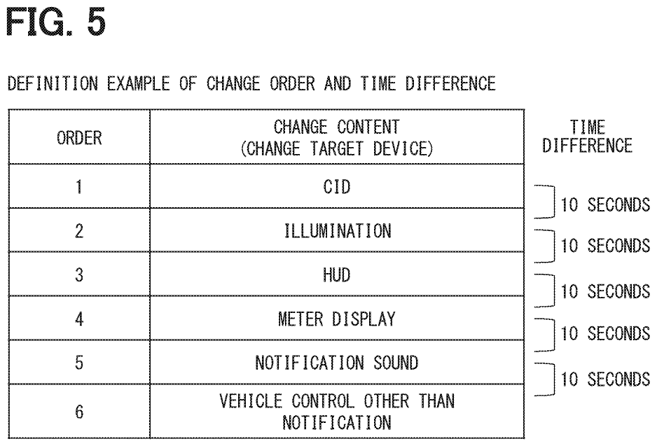

An example of the definition of the order and the time difference of the change here will be described with reference to FIG. 5. In the example of FIG. 5, it is assumed that the specification is defined in advance, and it is assumed that the software related to the vehicle control mode other than the notification is also integrally changed. In this case, the order of the software change may be defined for vehicle control modes other than the notification. The vehicle control mode other than the notification is, for example, a control mode by an algorithm for processing sensor data by the environment perception unit 11 and perceiving the external environment, or an algorithm related to a route planning functionality, a behavior planning functionality, and a trajectory planning functionality by the driving planning unit 22.

In the example shown in FIG. 5, the first is a display mode of the CID 70b2, the second is a display mode of an illumination unit, the third is a display mode of the HUD 70b3, the fourth is a display mode of the meter display 70b1, the fifth is a sound mode of a notification sound by a speaker, and the sixth is a vehicle control mode other than the notification. The set time differences are all set to a common value of 10 seconds.

As in this example, the CID 70b2 may be preferentially (first) changed. The vehicle user such as the driver can easily notice the start of the change by preferentially changing a notification mode of a device having the largest quantity of information that can be notified among the notification devices 70b mounted on the vehicle 1 such as the CID 70b2. Therefore, confusion during the change is less likely to occur than when time passes without the vehicle user noticing the start of change, and the vehicle user only notices the change in the notification mode after the change in most of the notification devices 70b has been completed.

When both the display mode and the sound mode are included in the changed notification mode as in this example, the display mode may be preferentially changed, and then the sound mode such as the notification sound may be changed. This is because the vehicle user such as the driver is more likely to notice the start of the change in the display mode than in the sound mode.

As in this example, when the software change includes both the change in the notification mode and the vehicle control mode other than the notification, the notification mode may be preferentially changed, and then the vehicle control mode other than the notification may be changed. This is because the vehicle user such as the driver more easily notices the start of the change in the notification mode than in the vehicle control mode other than the notification mode.

The software application unit MF1 may store the defined order and time difference of the change in the storage medium 55c of the recording device 55. Accordingly, when a trouble occurs in the vehicle 1 or the vehicle user during the software change, it is easy to verify the state during the trouble occurrence later.

The HMI cooperation unit MF3 may display a status during the change on the notification device 70b (for example, CID 70b2) whose notification mode is changed first until the changes in the notification mode of all the notification devices 70b are completed during the software change. The HMI cooperation unit MF3 may cause the notification device 70b currently being changed to display the status of being changed, instead of the notification device 70b whose notification mode has been changed first. The status of being changed may include information indicating that the change in the notification mode is being conducted. The status during the change may include information indicating which notification device 70b is the device whose notification mode is changed next.

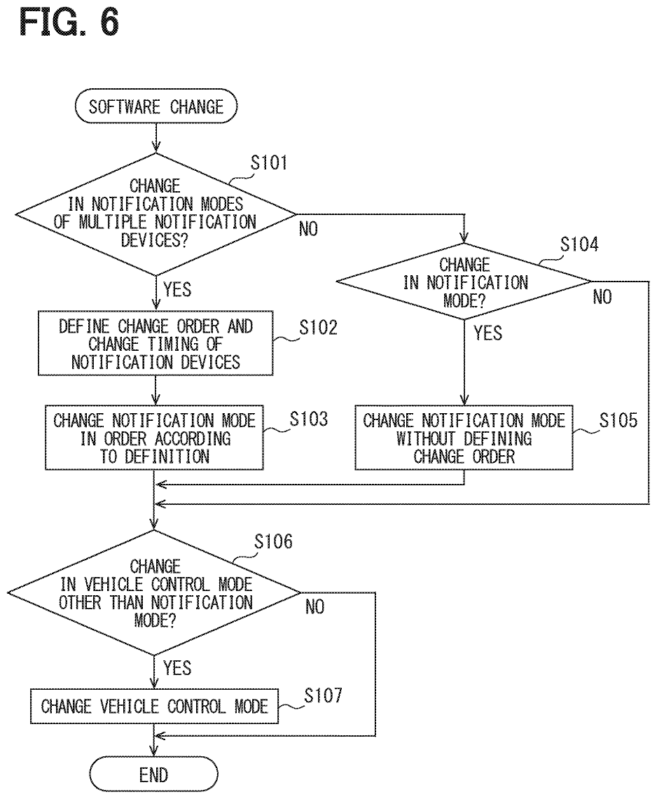

Next, an example of a software changing method will be described with reference to a flowchart in FIG. 6. In the series of processes, the processor 57b of the software management unit 57 executes a computer program stored in the memory 57a. In response to this, software for controlling the notification mode of each notification device 70b is updated, and the notification mode is changed. A trigger for starting the series of processes may be given by a command from the server 96, or may be given by an input operation on the operation input device 70a by the vehicle user.

In the first S101, the software application unit MF1 determines whether the current software change is to change display modes of the multiple notification devices 70b. If Yes, the process proceeds to S102. If No, the process proceeds to S104.

In S102, the software application unit MF1 defines a change order and a change timing between the multiple notification devices 70b. After the process in S102, the process proceeds to S103. In S103, the software application unit MF1 and the HMI cooperation unit MF3 change the notification mode in order according to the definition set in S102. Specifically, the software application unit MF1 switches the software related to the notification mode of the notification device 70b as a software change target. Then, the HMI cooperation unit MF3 controls each notification device 70b such that the notification modes are sequentially switched according to the defined change timing. After the process in S103, the process proceeds to S106.

On the other hand, in S104 when No is obtained in S101, the software application unit MF1 determines whether there is a change in the notification mode in the current software change. If Yes, the process proceeds to S105. The case of Yes is a case where the notification mode of one notification device 70b is substantially changed. If No, the notification mode is not changed, and therefore, the process proceeds to S106.

In S105, the software application unit MF1 and the HMI cooperation unit MF3 change the notification mode without defining the change order. After the process in S105, the process proceeds to S106.

In S106, the software application unit MF1 determines whether the current software change is to change the vehicle control mode other than the notification mode. If Yes, the process proceeds to S107. If No, all the software changes have been completed, and therefore, the series of processes is ended.

In S107, the software application unit MF1 changes all vehicle control modes other than the notification mode. The series of processes is ended after S107.

In S101 to S107, the change order and the change timing of the notification mode between the multiple notification devices 70b have been defined. However, as in the example shown in FIG. 5, the change order and the change timing may be defined including the vehicle control mode other than the notification mode. In this case, all change orders and change timings including the vehicle control mode other than the notification mode may be defined in S102 without performing the processes in S106 and S107, and the change may be conducted in order including the vehicle control mode other than the notification mode in S103.

According to the first embodiment described above, when the software change in the multiple notification devices 70b is conducted, the changes in the notification mode are distributed to different change timings. Therefore, a vehicle user such as a driver is restricted from being confused. In this way, the software change including the notification mode can be appropriately conducted.

According to the first embodiment, the order of the change timings of the notification mode is defined for the multiple notification devices 70b. The confusion of the vehicle user can be further reduced by changing the notification mode according to the defined order.

According to the first embodiment, when the software change further includes the vehicle control mode other than the notification mode, the vehicle control mode is changed after all the changes in the notification mode of the multiple notification devices 70b are completed in the conduction of the software change. The confusion of the vehicle user can be further reduced by also providing a time difference between the change timing of the notification mode and the change timing of the vehicle control mode. The vehicle user can notice the change at an early stage by completing the change in the more noticeable notification mode first.

According to the first embodiment, when the software change includes both the change in the display mode and the change in the sound mode, the sound mode is changed after all the changes in the display mode are completed in the conduction of the software change. The confusion of the vehicle user can be further reduced by also providing a time difference between the change timing of the display mode and the change timing of the sound mode. The vehicle user can notice the change at an early stage by completing the change in the more noticeable display mode first.

According to the first embodiment, the software change is the software change for starting the test including the test of the notification mode in the vehicle 1. The influence of the confusion during the software change on the evaluation of the test software can be restricted by reducing the confusion of the vehicle user at the start of the test. That is, the evaluation accuracy of the test software can be improved.

### Second Embodiment

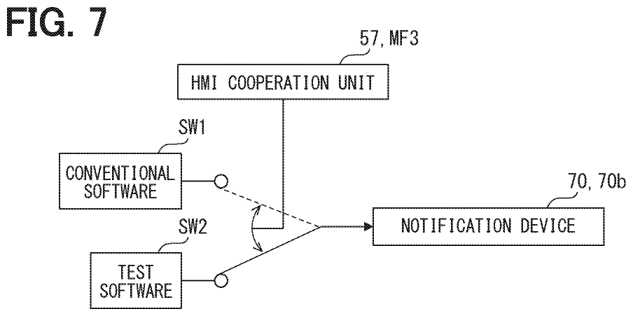

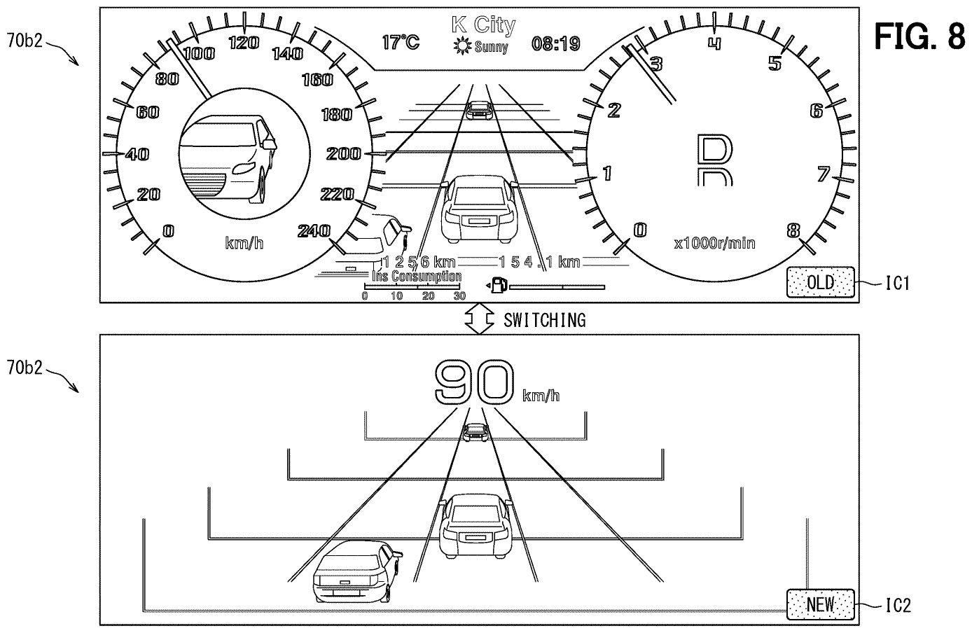

As illustrated in FIGS. 7 and 8, the second embodiment is a modification of the first embodiment. The second embodiment will be described focusing on differences from the first embodiment.

A test of test software which is an improved version of conventional software for controlling a notification mode of the notification device 70b will be described in detail in the second embodiment. This test is a test in which the vehicle user compares the conventional software with the test software and gives feedback using the feedback device 70a1 or the like.

The software application unit MF1 causes the conventional software to remain, additionally downloads the test software, and causes the test software and the conventional software to coexist. In this case, the hardware that stores the test software may be the same hardware as the hardware that stores the conventional software or may be another hardware. The same hardware may be a storage medium such as the memory 51a. The other hardware may be a storage medium such as the memory 57a of the software management unit 57, or may be a storage medium provided exclusively for testing.

As illustrated in FIG. 7, the HMI cooperation unit MF3 is able to switch software for controlling the notification mode of the notification device 70b in a coexistence state of the conventional software and the test software. That is, the test software is disabled while the conventional software is enabled. The conventional software is disabled while the test software is enabled.

The HMI cooperation unit MF3 repeatedly switches between the notification based on the conventional software and the notification based on the test software during a test conduction period. Here, a switching cycle of the notification mode may be set according to an amount of change in the notification mode. For example, in the case of a test in which the amount of change in the notification mode is small, such as only a change in a color of a velocity display of a virtual image VI by the HUD 70b3, the vehicle user hardly notices the change. Therefore, an occurrence interval between the switching events may be set to a short interval of shorter than 1 hour, such as 1 minute, 5 minutes, or 10 minutes, frequent switching occurs, and the vehicle user may easily notice the frequent switching. On the other hand, in the case of a test in which the amount of change in the display mode that affects the entire cockpit is large, such as a change in the role allocation of displays on the meter display 70b1, the CID 70b2, and the HUD 70b3, the vehicle user can easily notice the change. Therefore, the occurrence interval between the switching events may be set to a long interval of 1 hour or longer, such as 1 hour, 3 hours, or 6 hours, and the vehicle user may easily perform an appropriate evaluation by checking the long-time test mode.

The time set in the switching cycle referred to herein may not be a simple elapsed time, but may be a time obtained by counting only a time satisfying a predetermined condition according to the purpose of the test. For example, only the time during which the vehicle 1 is actually traveling may be counted. Only the time of automated driving may be counted, or only the time during which the vehicle user is manually driving the vehicle may be counted.

The notification based on the conventional software and the notification based on the test software may not be switched at equal intervals. During the test, the notification based on the conventional software is conducted in order for the vehicle user to check the point of change in the notification based on the test software. Therefore, the conduction time of the notification based on the test software may be set to be longer than the conduction time of the notification based on the conventional software.

In the test, when the change in the notification mode affects the multiple notification devices 70b, the HMI cooperation unit MF3 may substantially simultaneously switch the notification modes of all the notification devices 70b. This is because, when timings are separated, there is a timing at which the notification based on the conventional software and the notification based on the test software are mixed with each other, which may confuse the vehicle user. On the other hand, when it is desired to obtain an individual evaluation for each notification device 70b for the purpose of the test, the switching may be performed for each notification device 70b.

It is preferable to instantaneously switch the notification mode. For example, when the display mode is changed little by little over a long time, such as the fade-in/fade-out effect, it becomes difficult for the vehicle user to notice a point of change.

The HMI cooperation unit MF3 may postpone the switching timing when it is determined that the state is inappropriate for switching at the switching timing of the notification mode. The state inappropriate for switching may be, for example, a state under a hazardous situation, a state during execution of DDT fallback, an occurrence state of authority transfer, or a state in which a collision risk is higher than risk acceptance criteria/criterion.

When the test is conducted with the repeated switching, the HMI cooperation unit MF3 may cause the notification device 70b to conduct the notification indicating whether the current notification mode is a notification mode based on the test software, or a notification mode based on the conventional software, or a test status.

As illustrated in FIG. 8, the HMI cooperation unit MF3 may display icons IC1 and IC2 indicating test statuses at an end portion of a screen of the meter display 70b1 when the display mode of the meter display 70b1 as the display device is tested. While the notification mode based on the conventional software is adopted (see the upper part of FIG. 8), the icon IC1 including a character display of “old” is displayed. While the notification mode based on the test software is adopted (see the lower part of FIG. 8), the icon IC2 including a character display of “new” is displayed. The HMI cooperation unit MF3 may periodically conduct a notification of the test status with a notification sound by a speaker instead of displaying the icons IC1 and IC2.

The HMI cooperation unit MF3 may conduct a notification indicating the occurrence of the switching when the switching timing approaches. The notification indicating the occurrence of the switching may be started at a timing earlier than the switching timing by a preset time (for example, 10 seconds) and may be continued until the switching timing. The notification indicating the occurrence of the switching may be conducted by a character display of “switching” or may be conducted by an announcement such as “display will be switched soon” by a speaker.

According to the second embodiment described above, the software before the change and the software after the change coexist in at least one of the memories 51a and 57a in a switchable manner. During the test conduction period, the notification based on the conventional software and the notification based on the test software are repeatedly switched. Accordingly, the vehicle user who evaluates the software can easily notice the point of change in the test software with respect to the conventional software. Therefore, the evaluation accuracy of the test software can be improved.

According to the second embodiment, when the notification based on the test software is conducted in the repeated switching, the notification indicating whether the current notification is the notification based on the test software is conducted. This can prevent the vehicle user from erroneously recognizing whether the current notification mode is based on the conventional software or the test software. Therefore, the evaluation accuracy of the test software can be improved.

### Third Embodiment

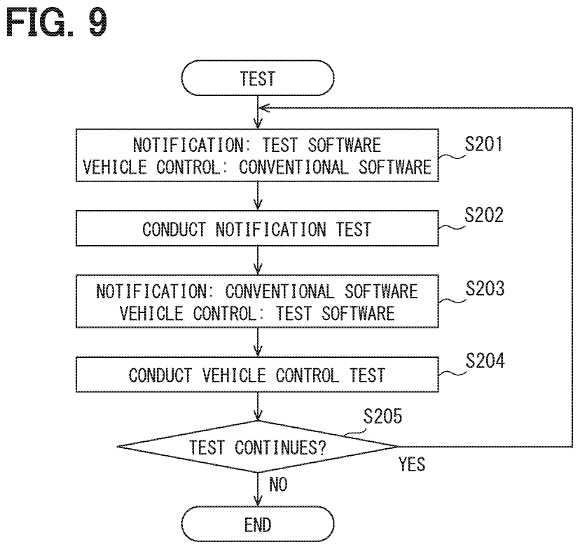

As illustrated in FIG. 9, the third embodiment is a modification of the second embodiment. The third embodiment will be described focusing on differences from the second embodiment.

In the third embodiment, the software change for the test includes both the software change related to the notification and the software change related to the vehicle control other than the notification (hereinafter, simply referred to as vehicle control). The conventional software and the test software coexist in a switchable manner for the notification, and the conventional software and the test software coexist in a switchable manner for the vehicle control.

The software application unit MF1 repeatedly switches between the notification based on the conventional software and the notification based on the test software during the test conduction period by using the same switching functionality as in the second embodiment. However, this switching also has a meaning of switching between the conduction state and the stop state of the test of the notification mode. The software application unit MF1 repeatedly switches between vehicle control based on the conventional software and vehicle control based on the test software during the test conduction period. This switching also means switching between the conduction state and the stop state of the test of the vehicle control mode.

The software application unit MF1 links the switching between the test software and the conventional software such that the vehicle control switches to the conventional software when the notification is the test software, and the vehicle control switches to the test software when the notification is the conventional software. By doing so, the notification test and the vehicle control test can be alternately conducted. The vehicle user is more likely to notice the start of the test when the notification test is conducted than the case where the vehicle control test is conducted first.

When the change in the notification mode affects the multiple notification devices 70b, the software application unit MF1 may substantially simultaneously switch the notification modes of all the notification devices 70b. On the other hand, the software application unit MF1 may switch only the notification mode of one notification device 70b in response to one switching. Then, the tests may also be implemented as follows. For example, a test of the CID 70b2 is conducted, a test of vehicle control is conducted next, a test of the HUD 70b3 is conducted next, a test of vehicle control is conducted next, and a test of the meter display 70b1 is conducted next.

Next, an example of a test method will be described with reference to a flowchart in FIG. 9. In the series of processes, the processor 57b of the software management unit 57 executes a computer program stored in the memory 57a. In response to this, the notification mode of each notification device 70b, the computer 51, and the like are controlled. A trigger for starting the series of processes may be given by a command from the server 96, or may be given by an input operation on the operation input device 70a by the vehicle user.

In the first S201, the software application unit MF1 switches the notification to the test software and switches the vehicle control to the conventional software. In S202 after the processing in S201, a notification test is conducted.

In S203 after the process in S202, the software application unit MF1 switches the notification to the conventional software and switches the vehicle control to the test software. In S204 after the process in S203, a test of vehicle control is conducted.

In S205 after the process in S204, the software application unit MF1 determines whether to continue the test. If Yes, the process returns to S201. If No, the test is ended.

According to the third embodiment described above, when the test further includes the test of the vehicle control mode other than the notification mode, the test of the notification mode and the test of the vehicle control mode are alternately conducted. The alternate conduction makes it easy for the vehicle user who evaluates the software to notice the change point of the notification mode based on the test software with respect to the notification mode based on the conventional software. In addition, various tests can be efficiently conducted by conducting the test of the vehicle control mode while the notification mode based on the conventional software is obtained without conducting the test of the notification mode.

### Fourth Embodiment

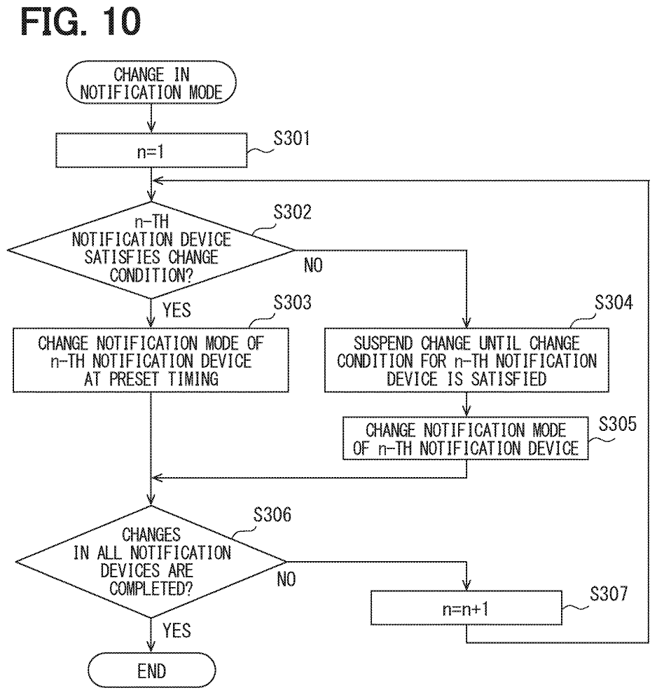

As illustrated in FIG. 10, the fourth embodiment is a modification of the first embodiment. The fourth embodiment will be described focusing on differences from the first embodiment.

In the fourth embodiment, when the notification mode is actually changed in S103 according to the order of changing the notification mode defined in S102, the HMI cooperation unit MF3 refers to a change condition individually set in advance for each notification device 70b. The HMI cooperation unit MF3 changes the notification mode so as to satisfy the change condition. In other words, when the change condition is not satisfied, the change in the notification mode of the notification device 70b is suspended. The suspension may be postponement. That is, the change condition may be a condition for allowing a change.

For example, the change conditions of the meter display 70b1, the CID 70b2, and the HUD 70b3 may include a condition that the traveling stability is higher than a preset threshold. A collision risk may be adopted instead of or in addition to the traveling stability. For example, at the time of switching the automation level, at the time of entering and leaving an expressway, or at the time of starting or ending a driving assistance application such as an adaptive cruise control (ACC) application in the vehicle 1 traveling at the automation level of level 2, it may be determined that the traveling stability is lower than a threshold, and the change in the notification mode may be suspended. For example, when the number of surrounding vehicles traveling around the vehicle 1 is larger than a preset number of vehicles, it may be determined that the collision risk is lower than a threshold, and the change in the notification mode may be suspended. The number of surrounding vehicles may be the number of vehicles detected by the external environment sensor 41.

A change condition stricter than that of another notification device 70b may be imposed on the meter display 70b1. For example, the change condition for the meter display 70b1 may further include a condition that the vehicle 1 is being stopped. This is because suddenly switching these notification modes during traveling is not appropriate for the vehicle 1 because the meter display 70b1 displays the basic vehicle state including the velocity and the like of the vehicle 1.

The HMI cooperation unit MF3 may generate information on the change condition and store the information in the storage medium 55c of the recording device 55. The information on the change condition may include a change condition for each notification device 70b and a determination result for the change condition. The information on the change condition may include at least one of a time point when the determination is made and a time point when the notification mode is actually changed by the determination. The information on the change condition may include the definition of the order and time difference of the change described in the first embodiment. Accordingly, when a trouble occurs in the vehicle 1 or the vehicle user during the software change, it is easy to verify the state during the trouble occurrence later.

Next, a detailed example of a method of changing the notification mode in S103 will be described with reference to a flowchart in FIG. 10. In the series of processes, the processor 57b of the software management unit 57 executes a computer program stored in the memory 57a. In response to this, the notification mode of each notification device 70b, the computer 51, and the like are controlled.

In S301, a variable n indicating the change order stored in the memory 57a is set to n=1. Here, n is an integer of 1 or more. After the process in S301, the process proceeds to S302.

In S302, the HMI cooperation unit MF3 determines whether the n-th notification device 70b satisfies the change condition. The change condition refers to the change condition individually set as described above. If Yes, the process proceeds to S303. If No, the process proceeds to S304.

In S303 when it is determined that the change condition is satisfied, the HMI cooperation unit MF3 changes the notification mode of the n-th notification device 70b at the change timing defined in S102 of FIG. 6. The change timing may be defined by the time difference with the (n−1)-th notification device 70b as in the first embodiment. After the process in S303, the process proceeds to S306.

In S304 when it is determined that the change condition is not satisfied, the HMI cooperation unit MF3 suspends the change in the notification mode until the change condition of the n-th notification device is satisfied. In S304, the HMI cooperation unit MF3 may re-determine whether the change condition is satisfied at preset intervals. When the change condition is satisfied, the process in S304 is ended, and the process proceeds to S305. In S305, the HMI cooperation unit MF3 changes the notification mode of the n-th notification device 70b. After the process in S305, the process proceeds to S306.

In S306, the HMI cooperation unit MF3 determines whether the changes in the notification modes in all the notification devices 70b as the software change target are completed. If Yes, the series of processes is ended. If No, the process proceeds to S307. In S307, in order to perform the process by the notification device 70b in the next change order, n=n+1. That is, the variable n is incremented. After the process in S307, the process returns to S302.

When the n-th notification device 70b does not satisfy the change condition in S302, the order itself may be changed. For example, when the determination in S302 is No, the process may proceed to S307, and the change in the notification mode in the next (n+1)-th notification device 70b may be conducted first. In this case, the process for the notification device 70b originally defined as the n-th notification device may be conducted again immediately after the process for the (n+1)-th notification device 70b is completed, or may be conducted again after a series of processes for notification devices 70b including the other notification devices 70b is completed.

According to the fourth embodiment described above, in the conduction of the software change, the change conditions for the notification modes differ depending on the type of the notification device 70b. Accordingly, the software change optimized according to the characteristics of each notification device 70b can be conducted.

According to the fourth embodiment, when it is determined that the change condition for the notification mode is not satisfied in the conduction of the software change, the timing for changing the notification mode is postponed. By performing the change again at the timing when the change condition is satisfied by the postponement, the confusion of the vehicle user can be further reduced.

### Fifth Embodiment

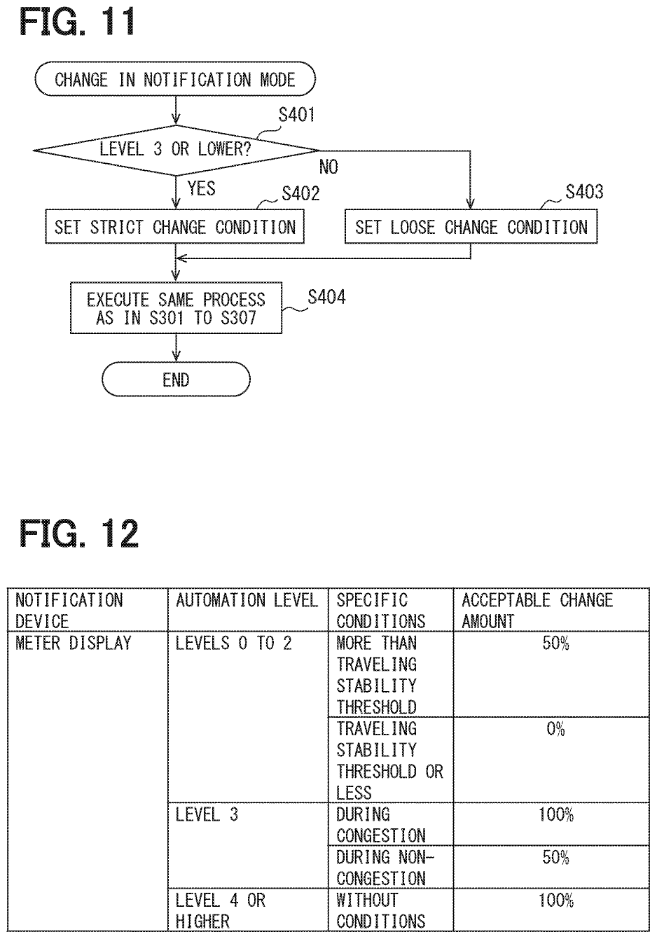

As illustrated in FIG. 11, the fifth embodiment is a modification of the fourth embodiment. The fifth embodiment will be described focusing on differences from the fourth embodiment.

In the fifth embodiment, in the vehicle 1 capable of switching the automation level, the HMI cooperation unit MF3 varies the change condition according to the automation level. Here, being capable of switching the automation level may be being capable of switching all of the levels among levels 1 to 5, or being capable of switching some levels, two or more levels of levels 1 to 5. For example, switching may be possible only between level 0 and level 3, or switching may be possible among level 0, level 2, and level 4.

For example, the HMI cooperation unit MF3 varies the change condition between a case where the automation level is 3 or lower and a case where the automation level is 4 or higher. When the automation level is 3 or lower, the load of the driving task on the driver is increased, and thus the change condition is set more strictly than the case where the automation level is 4 or higher.

As an example, when the automation level is 3 or lower, the change condition for the meter display 70b1 includes a condition that the vehicle 1 is being stopped as in the third embodiment. On the other hand, when the automation level is 4 or higher, it is assumed that there is substantially no change condition for all the notification devices 70b. That is, the HMI cooperation unit MF3 can change the notification mode at any change timing.

When the notification mode can be changed at any change timing, the HMI cooperation unit MF3 can change the notification mode of each notification device 70b at a preferred timing of the vehicle user. For example, the notification mode may be changed at a timing according to an operation of requesting the vehicle user to perform a change on the change interface displayed in the CID 70b2.

Next, a detailed example of a method of changing the notification mode in S103 will be described with reference to a flowchart in FIG. 11. In the series of processes, the processor 57b of the software management unit 57 executes a computer program stored in the memory 57a. In response to this, the notification mode of each notification device 70b, the computer 51, and the like are controlled.

In S401, the HMI cooperation unit MF3 determines whether the current automation level is 3 or lower. If Yes, the process proceeds to S402. If No, the process proceeds to S403.

In S402, the HMI cooperation unit MF3 sets a change condition that is relatively stricter than the case where the automation level is 4 or higher. After the process in S402, the process proceeds to S404.

In S403, the HMI cooperation unit MF3 sets a relatively looser change condition than the case where the automation level is 3 or lower. After the process in S403, the process proceeds to S404.

In S404, the HMI cooperation unit MF3 executes the same processes as S301 to S307 in FIG. 10, and changes the notification mode of each notification device 70b in order. The series of processes is ended after the process in S404.

As described above, there may be substantially no change condition, and the control that can change the notification mode at any change timing may be set. In this case, after the process in S403, instead of S404, the HMI cooperation unit MF3 causes the HMI device 70 (for example, the CID 70b2) to transition to a state in which the change operation is received by the change interface.

According to the fifth embodiment described above, in the conduction of the software change, the change condition for the notification mode differs depending on the current automation level. The load of the driving task on the driver changes according to the automation level, and therefore, confusion of the driver in the software change can be reduced by setting an appropriate change condition according to the load.

### Sixth Embodiment

As illustrated in FIG. 12, the sixth embodiment is a modification of the fourth embodiment. The sixth embodiment will be described focusing on differences from the fourth embodiment.

In the sixth embodiment, the change condition is set by a combination of a specific condition and an acceptable change amount accepted by the specific condition. The acceptable change amount referred to here may be the maximum amount at which the change in the display mode is accepted at a time. The acceptable change amount may be represented by, for example, a percentage of an area of a screen of a display device.

FIG. 12 illustrates an example of change conditions for the meter display 70b1. This change condition varies depending on the automation level. More specifically, the change conditions change when the automation level is 0 to 2, when the automation level is 3, and when the automation level is 4 or higher.

In the case of the levels 0 to 2, when the traveling stability is larger than a preset threshold, the acceptable change amount is set to 50%. That is, the display mode of the meter display 70b1 is allowed to be changed by an amount corresponding to the maximum 50% of the area of the screen. That is, the determination in S302 of FIG. 10 is Yes, and the display mode is changed at one time by the maximum half area in S303. When all the changes to the meter display 70b1 are not completed, the process in S302 may be conducted again without conducting the increment in S307. On the other hand, when the traveling stability is equal to or less than the preset threshold, the change itself is not allowed. That is, the determination in S302 of FIG. 10 is inevitably No.

In the case of level 3, the acceptable change amount is set to 100% in the case of traffic congestion. That is, the determination in S302 of FIG. 10 is Yes, and all changes for the meter display 70b1 are completed at once in S303. On the other hand, when there is no traffic congestion, the acceptable change amount is set to 50%. In the case of level 4 or higher, the acceptable change amount is unconditionally set to 100.

In the sixth embodiment described above, in the conduction of the software change, the change amount of the notification mode at one change timing is gradually increased as the load of the driving task on the driver of the vehicle 1 decreases. The confusion of the driver in the software change can be reduced by further adjusting the change amount of the notification mode.

### Seventh Embodiment

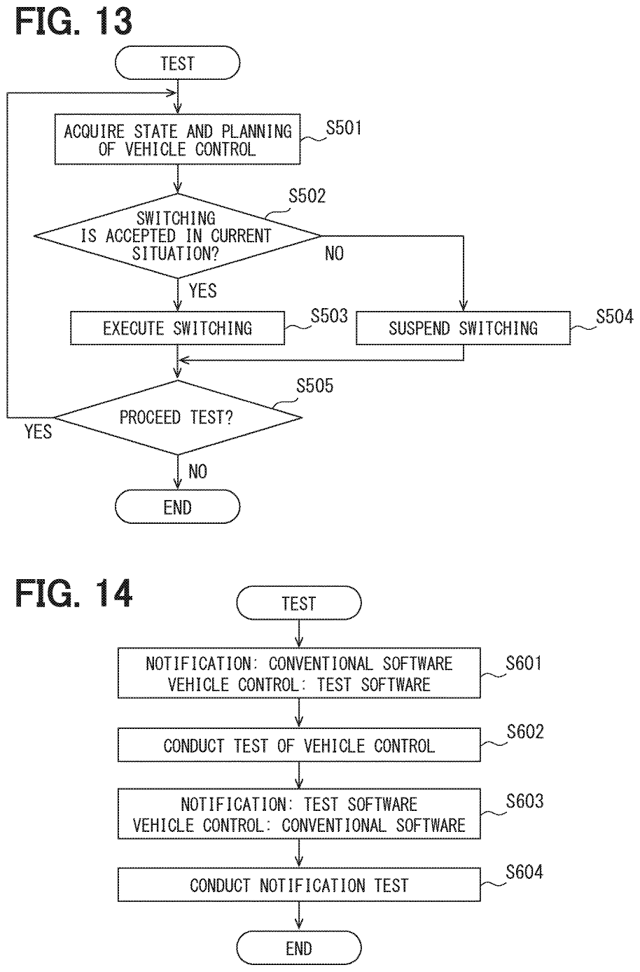

As illustrated in FIG. 13, the seventh embodiment is a modification of the second embodiment. The seventh embodiment will be described focusing on differences from the second embodiment.

In the seventh embodiment, the HMI cooperation unit MF3 also repeatedly switches between the notification mode based on the conventional software and the notification mode based on the test software during the test conduction period. However, the switching is not periodically performed, and the HMI cooperation unit MF3 sets the switching timing to a timing according to the traveling control of the vehicle 1.

More specifically, the HMI cooperation unit MF3 acquires information on the traveling control of the vehicle 1 such as information on the automated driving mode and planning information from the planning unit 20, and determines whether the current situation is a situation in which switching of the notification mode is accepted. In the situation where the switching is accepted, the switching of the notification mode is quickly executed. In a situation where the switching is not accepted, the switching of the notification mode is temporarily suspended.

Whether the switching is accepted is determined based on the viewpoint that whether the switching can be understood by the driver or whether the traveling of the vehicle 1 is adversely affected by the switching.

As a first example of the determination criterion, when the vehicle 1 is merging or change lanes, when the vehicle 1 is passing through an intersection, when there is a high possibility that a large change in the traveling environment or a change in the control state of the vehicle 1 actually occurs, such as during execution of MRM, during execution of DDT fallback, during execution of takeover, or the like, switching of the notification mode is suspended. On the other hand, when the vehicle 1 simply travels on a straight road, switching of the notification mode may be executed.

As a second example of the determination criterion, when the vehicle 1 is traveling, switching of the notification mode may be suspended. On the other hand, when the vehicle 1 is being stopped (including waiting caused by a stop signal), switching of the notification mode may be executed. In this way, it may be determined whether switching is possible according to the velocity of the vehicle 1.

As a third example of the determination criterion, the switching of the notification mode may be suspended when an engine switch of the vehicle 1 is in the ON state (state in which the vehicle 1 can travel), and the switching may be executed only when the engine switch is switched to the OFF state.

The determination criterion may be changed according to the magnitude of the change in the notification mode during switching. For example, when the change in the notification mode such as a change in the display font or the size is small, the determination criterion shown in the first example may be adopted, and when the change is large such as a significant change in the display layout or the display content, the determination criterion shown in the second and third examples may be adopted.

Next, a detailed example of a method of switching the notification mode in the test conduction period will be described with reference to a flowchart in FIG. 13. In the series of processes, the processor 57b of the software management unit 57 executes a computer program stored in the memory 57a. In response to this, the notification mode of each notification device 70b, the computer 51, and the like are controlled.

In the first S501, the HMI cooperation unit MF3 acquires information on the state and planning of the vehicle control. After the process in S501, the process proceeds to S502.

In S502, the HMI cooperation unit MF3 determines, based on the information acquired in S501, whether it is a situation in which the switching of the notification mode is accepted. If Yes, the process proceeds to S503. If No, the process proceeds to S504.

In S503, the HMI cooperation unit MF3 executes switching once between the notification mode before the change and the notification mode after the change. On the other hand, in S504, the HMI cooperation unit MF3 suspends switching of the notification mode. After the processes in S503 and S504, the process proceeds to S505.

In S505, the HMI cooperation unit MF3 determines whether the test proceeds. If Yes, the process returns to S501 after a predetermined time. If No, the series of processes is ended.

According to the seventh embodiment described above, the notification based on the software before the change and the notification based on the software after the change are repeatedly switched. The switching timing here is set to a timing according to the traveling control of the vehicle 1. The test can be conducted more appropriately by considering the traveling control.

### Eighth Embodiment

As illustrated in FIG. 14, the eighth embodiment is a modification of the third embodiment. The eighth embodiment will be described focusing on differences from the third embodiment.

In the third embodiment, the vehicle control test and the notification test are alternately and repeatedly conducted, but in the eighth embodiment, the software application unit MF1 starts the other test after one test is completed. For example, the software application unit MF1 first conducts a test of vehicle control having a larger degree of influence on the external environment, and then conducts a test of notification.

An example of a test method will be described with reference to a flowchart in FIG. 14. In the series of processes, the processor 57b of the software management unit 57 executes a computer program stored in the memory 57a. In response to this, the notification mode of each notification device 70b, the computer 51, and the like are controlled.

In the first S601, the software application unit MF1 switches the notification to the conventional software and switches the vehicle control to the test software. In S602 after the process in S601, a test of the vehicle control is conducted.

In the S603 after all the tests of the vehicle control are completed, the software application unit MF1 switches the notification to the test software and switches the vehicle control to the conventional software. In S604 after the process in S603, a test of the notification is conducted.

According to the eighth embodiment described above, one of the test of the notification mode and the test of the vehicle control mode is started, and after the one is completed, the other one is started. In this way, both tests are executed with the conduction periods separated, and therefore, the vehicle user can be restricted from being confused.

### Ninth Embodiment

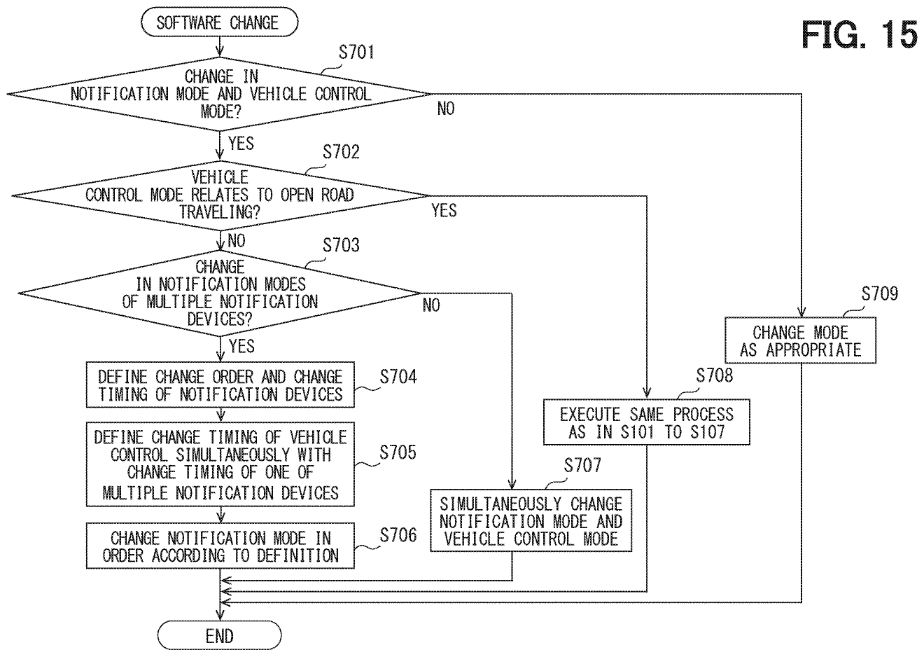

As illustrated in FIG. 15, the ninth embodiment is a modification of the first embodiment. The ninth embodiment will be described focusing on differences from the first embodiment.

In the first embodiment, a time difference is provided between the change timings of the notification mode and the vehicle control mode. On the other hand, in the ninth embodiment, when the change in the vehicle control mode is a change that is not related to traveling of the vehicle 1 on an open road, the software application unit MF1 matches (for example, at the same time) the change timings between the notification mode and the vehicle control mode.

The change related to traveling on an open road includes a change in an algorithm related to a lane change on an open road, a change in an algorithm related to the MRM, and the like. The change not related to traveling on an open road is a change in an algorithm related to automatic parking in a parking lot, a change in an algorithm for remotely starting an engine switch of the vehicle 1, or the like.

Next, an example of a software change method will be described with reference to the flowchart in FIG. 15. In the series of processes, the processor 57b of the software management unit 57 executes a computer program stored in the memory 57a. In response to this, the software for controlling the notification mode of each notification device 70b is updated, the notification mode is changed, and the software for controlling the vehicle control mode is updated.

In the first S701, the software application unit MF1 determines whether the current software change is to change both the notification mode and the vehicle control mode. If Yes, the process proceeds to S702. If No, the process proceeds to S709.

In S702, the software application unit MF1 determines whether the vehicle control mode to be changed this time is related to traveling of the vehicle 1 on an open road. If Yes, the process proceeds to S703. If No, the process proceeds to S708.

In S703, the software application unit MF1 determines whether the software change at this time is to change the display mode of the multiple notification devices 70b. If Yes, the process proceeds to S704. If No, the process proceeds to S707.

In S704, the software application unit MF1 defines a change order and a change timing between the multiple notification devices 70b. After the process in S704, the process proceeds to S705. In S705, the software application unit MF1 defines the change timing of the vehicle control mode to be the same as the change timing of any notification device 70b whose notification mode is to be changed. After the process in S705, the process proceeds to S706. In S706, the HMI cooperation unit MF3 controls each notification device 70b to sequentially switch the notification mode according to the defined change timing, and the software application unit MF1 updates the software related to the change in the vehicle control mode. The series of processes is ended after S706.

On the other hand, in S707 when the notification mode of one notification device 70b is changed, the software application unit MF1 simultaneously changes the notification mode and the vehicle control mode. The series of processes is ended after S707.

On the other hand, in S708 when the change in the vehicle control mode is a change related to traveling on an open road, the software application unit MF1 and the HMI cooperation unit MF3 execute the same processes as S101 to S107 in FIG. 6. The series of processes is ended after S708. On the other hand, in S709 in which the software change does not change both the notification mode and the vehicle control mode, the mode may be changed as appropriate. The series of processes is ended after S709.

According to the ninth embodiment described above, the software change further includes the vehicle control mode other than the notification mode, and the vehicle control mode is not related to traveling of the vehicle 1 on an open road. In this case, in the software change, the change in the vehicle control mode is executed in accordance with, for example, at the change timing of the notification mode of at least one of the multiple notification devices. The change can be quickly conducted by matching the change in the vehicle control mode that does not affect the open road traveling with the change in the notification mode.

### Tenth Embodiment

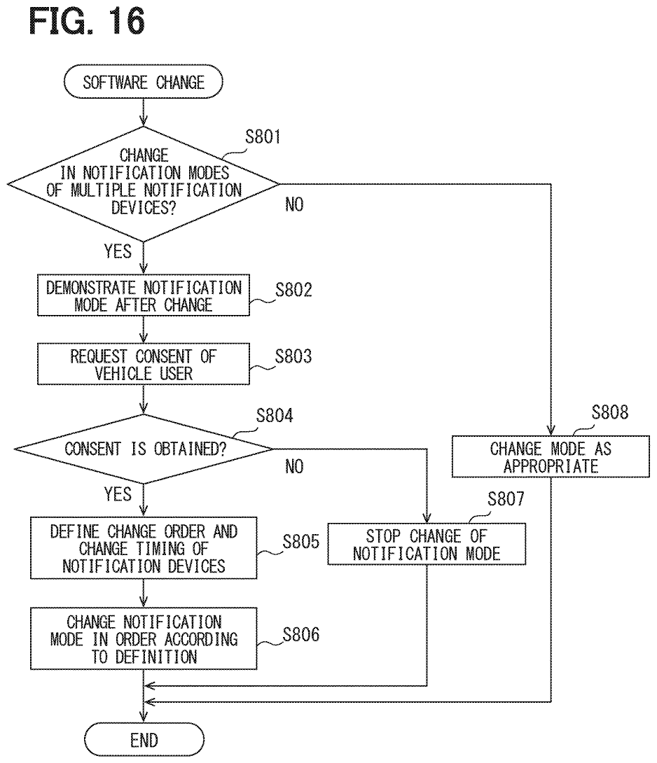

As illustrated in FIG. 16, the tenth embodiment is a modification of the first embodiment. The tenth embodiment will be described focusing on differences from the first embodiment.

The tenth embodiment is particularly suitable for updating software related to a notification mode, which is conducted regardless of a test. The notification mode applied to the vehicle 1 allows the preference of the vehicle user such as the driver. Therefore, the software application unit MF1 changes the software when the driver consents to the software change, and maintains the current state without changing the software when the driver rejects the software change.

In order to determine whether the vehicle user consents to the change, the software application unit MF1 downloads and installs simple version software for demonstration. Then, the HMI cooperation unit MF3 controls the multiple notification devices 70b to demonstrate the notification mode after the change in the actual vehicle 1. The time during which the demonstration is conducted may be set to a time sufficient for the vehicle user to make a determination, such as 30 seconds or 1 minute, and a time during which the vehicle user is less likely to feel annoyed. In the demonstration of the notification mode, the main display may or may not be switchable by the operation of the vehicle user.

Next, an example of a software change method will be described with reference to a flowchart in FIG. 16. In the series of processes, the processor 57b of the software management unit 57 executes a computer program stored in the memory 57a. In response to this, software for controlling the notification mode of each notification device 70b is updated, and the notification mode is changed.

In the first S801, the software application unit MF1 determines whether the software change at this time is to change the display modes of the multiple notification devices 70b. If Yes, the process proceeds to S802. If No, the process proceeds to S808.

In S802, the software application unit MF1 downloads and installs simple version software for demonstration, and the HMI cooperation unit MF3 controls the multiple notification devices 70b to demonstrate the notification mode after the change. In S803 after the process in S802, the software application unit MF1 and the HMI cooperation unit MF3 request the vehicle user to indicate an intention regarding whether to consent to the software change using the operation input device 70a. Specifically, a display requesting an operation input is output to the notification device 70b. After the process in S803, the process proceeds to S804.

In S804, the software application unit MF1 determines whether the consent of the vehicle user to the software change is obtained or not. If Yes, the process proceeds to S805. If No, the process proceeds to S807.

When the consent is obtained, in S805 w the software application unit MF1 downloads the software after the change and defines the change order and the change timing between the multiple notification devices 70b. After the process in S805, in S806, the software application unit MF1 and the HMI cooperation unit MF3 sequentially change the notification mode according to the definition set in S805. The series of processes is ended after S806.

On the other hand, when the consent is not obtained, in S807, the software application unit MF1 stops the change in the notification mode. The series of processes is ended after S807.

On the other hand, in S808 in which the notification modes of the multiple notification devices 70b are not changed, the modes may be changed as appropriate. The series of processes is ended after S808.

According to the tenth embodiment described above, after the schedule of the software change is specified, the notification mode after the change resulting from the software change is demonstrated by the multiple notification devices 70b, and the driver of the vehicle is requested to consent to the software change. When the consent is obtained, the software is changed with a time difference. The vehicle user can consent to the change after feeling the notification mode after the software change. The sense of satisfaction of the vehicle user can be enhanced, and therefore, the software change including the notification mode can be appropriately conducted.

### Eleventh Embodiment

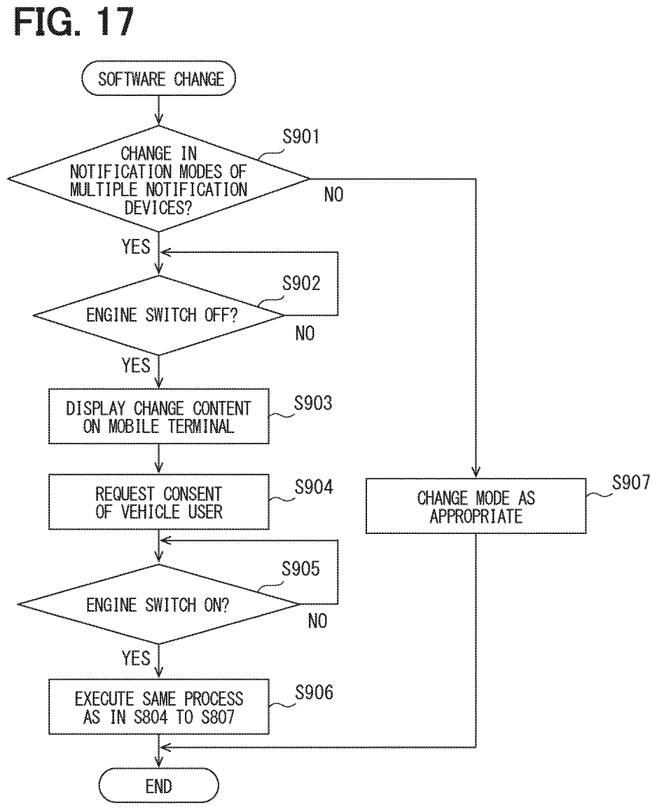

As illustrated in FIG. 17, the eleventh embodiment is a modification of the tenth embodiment. The eleventh embodiment will be described focusing on differences from the tenth embodiment.

In the eleventh embodiment, for the vehicle user who feels annoyed by the time for checking the demonstration of the notification mode in the vehicle 1, the HMI cooperation unit MF3 causes the smartphone of the vehicle user as the mobile terminal 91 to display the change content of the notification mode as the advance notice of the change.

The change content displayed on the smartphone may be indicated by characters summarizing the point of change. The changed content may be indicated by a notification image in which the notification mode after the change is reproduced on the screen of the smartphone.

The advance notice of the change may be executed, for example, when the engine switch of the vehicle 1 is switched from the ON state to the OFF state. For example, the HMI cooperation unit MF3 requests the smartphone to output a push notification at a timing when the engine switch is turned off. Accordingly, the vehicle user can perceive the change content by checking the push notification at any time after riding from the vehicle 1.

After the change content is displayed, the software application unit MF1 and the HMI cooperation unit MF3 request the vehicle user to indicate, using the smartphone, an intention regarding whether to consent to the software change. The information on the indication of intention input by the vehicle user is transmitted to the vehicle 1. Note that a Web browser may be used or a dedicated application may be used to obtain the advance notice of the change and consent.

When the consent can be acquired, the software application unit MF1 and the HMI cooperation unit MF3 change the notification mode, for example, when the engine switch is turned off again.

Next, an example of a software change method will be described with reference to the flowchart in FIG. 17. In the series of processes, the processor 57b of the software management unit 57 executes a computer program stored in the memory 57a. In response to this, software for controlling the notification mode of each notification device 70b is updated, and the notification mode is changed.

In the first S901, the software application unit MF1 determines whether the current software change is to change the display mode of the multiple notification devices 70b. If Yes, the process proceeds to S902. If No, the process proceeds to S907.

In S902, the software application unit MF1 determines whether the engine switch of the vehicle 1 has been changed from the ON state to the OFF state. If Yes, the process proceeds to S903. If No, the process in S902 is executed again after a predetermined time.

In S903, the HMI cooperation unit MF3 displays the change content of the notification mode on the mobile terminal 91. In S904 after the process in S903, the software application unit MF1 and the HMI cooperation unit MF3 request the vehicle user to indicate, using the mobile terminal 91, an intention regarding whether to consent to the software change. After the process in S904, the process proceeds to S905.

In S905, the software application unit MF1 determines whether the engine switch of the vehicle 1 has been changed from the off state to the ON state. If Yes, the process proceeds to S906. If No, the process in S905 is executed again after a predetermined time.

In S906, the software application unit MF1 and the HMI cooperation unit MF3 execute the same processes as S804 to S807 in FIG. 16. The series of processes is ended after S906. On the other hand, in S907 when the software change does not change the notification modes of the multiple notification devices 70b, the mode may be changed as appropriate. The series of processes is ended after S907.

According to the eleventh embodiment described above, the software management unit 57 is communicably connected to the mobile terminal 91 such as a smartphone. After the schedule of the software change is specified, the mobile terminal 91 gives an advance notice of the software change and requests the vehicle user to consent to the software change. When the consent is obtained, the software is changed with a time difference. The advance notice is performed by the mobile terminal 91, and therefore, it is possible to reduce the annoyance that the vehicle user takes time to check the notification mode in a state of being in the vehicle 1. The sense of satisfaction of the vehicle user can be enhanced by the consent, and therefore, the software change including the notification mode can be appropriately conducted.

According to the eleventh embodiment, when the engine switch of the vehicle 1 is switched from the ON state to the OFF state, the advance notice of the software change is conducted. When the engine switch is turned on again, the software is changed with a time difference. The start timing of the advance notice is linked with the turning off of the engine switch, and therefore, the vehicle user can be guided to check the advance notice at the gap time after getting off the vehicle. As a result, the annoyance felt by the vehicle user can be reduced.

### Other Embodiments

Although multiple embodiments are described above, the present disclosure is not construed as being limited to these embodiments, and can be applied to various embodiments and combinations within a scope that does not depart from the gist of the present disclosure.

As another embodiment, the vehicle 1 that is a target to be subjected to the software change may be a vehicle that does not support so-called automated driving with an automation level of 2 or lower so that a time difference is provided between the change timings of the notification modes among the multiple notification devices 70b.

As another embodiment, the vehicle 1 that is a target to be subjected to the software change may be a vehicle that does not have a functionality of conducting a test such as an AB test when participating in open road traffic so that a time difference is provided between the change timings of the notification modes among the multiple notification devices 70b. The software change in which the time difference is provided may be an update of software conducted regardless of the test.

As another embodiment, in the change order defined in S102 illustrated in FIG. 6, the notification mode of the meter display 70b1 may be changed first from the viewpoint of the driver's awareness. When the notification mode of the display for passengers placed in the rear seat is changed, the notification mode of the display may be changed last, or the notification mode may be changed substantially simultaneously with the change in the notification mode of the other notification device 70b, because the influence of the change on the driver is extremely small. When a change in the sound mode or the vehicle control mode other than the notification is closely related to a change in the display mode of a specific display device, the sound mode or the vehicle control mode closely related to the change in the display mode and the change in the display mode may be changed substantially simultaneously.

As another embodiment, in the second embodiment, the notification indicating the test status is conducted during the test, but the notification indicating the test status may be restricted according to the purpose of the test. For example, when it is desired to conduct a punching test on the vehicle user and evaluate a behavior change in the vehicle user, or when the vehicle user may be confused due to too much information when the notification indicating the test status is conducted, the HMI cooperation unit MF3 may not consistently conduct the notification indicating the test status during the conduction of the test. When the emergency vehicle approaches the vehicle 1, or when the vehicle user wants to gaze at a state other than the test status, such as a state during the execution of the DDT fallback or the MRM, the HMI cooperation unit MF3 may not temporarily conduct the notification indicating the test status.

As another embodiment, some of the notification devices 70b may be simultaneously changed as long as a time difference is provided between the change timings of the notification modes among the multiple notification devices. The acceptable change amount in the sixth embodiment may be the maximum number of notification devices 70b for which the change in the notification mode is accepted at the same time.

As another embodiment, before starting the software change including the change in the vehicle control mode, the software application unit MF1 may determine whether the preparation of the vehicle user is completed. The test may be started when the preparation is completed, and the start of the test may be suspended when the preparation is not completed. When the occupant (for example, the driver) is wearing a seat belt, it may be determined that the preparation is completed. When the vehicle 1 is traveling at a low velocity (traveling at a velocity equal to or lower than a preset velocity) or is stopped, it may be determined that the preparation is completed. The software change including the change in the vehicle control mode may be a change for conducting a test related to the vehicle control, or may be an update of software conducted regardless of the test.

As another embodiment, the software change including the change in the notification mode may be suspended when the vehicle 1 is traveling at the automation levels of 0 to 2. For example, when the automation level shifts to 3 or higher, the suspension may be canceled. For example, when the vehicle stops, the suspension may be canceled.

When a time difference is provided between the change timings of the notification modes among the multiple notification devices 70b, the time required for the change becomes longer. Therefore, as another embodiment, the HMI cooperation unit MF3 may output, using a speaker, a sound suitable for changing the display mode during the change. The sound suitable for changing the display mode may be, for example, a sound indicating that the notification mode is being changed. Alternatively, the sound suitable for the change in the display mode may be a relaxing sound (relaxing music, relaxing tweet, or the like) that allows the vehicle user to relax during the time required for the change.

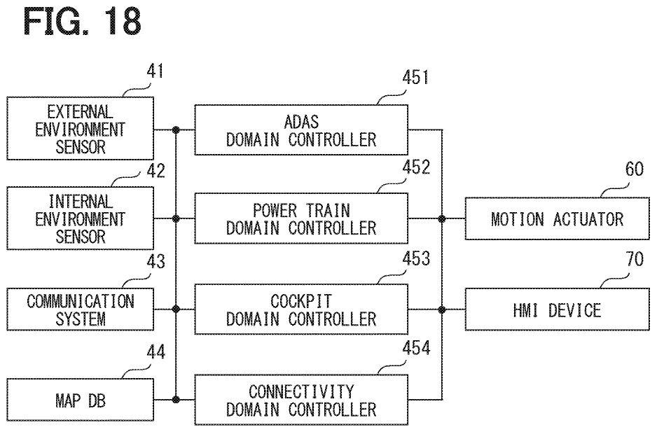

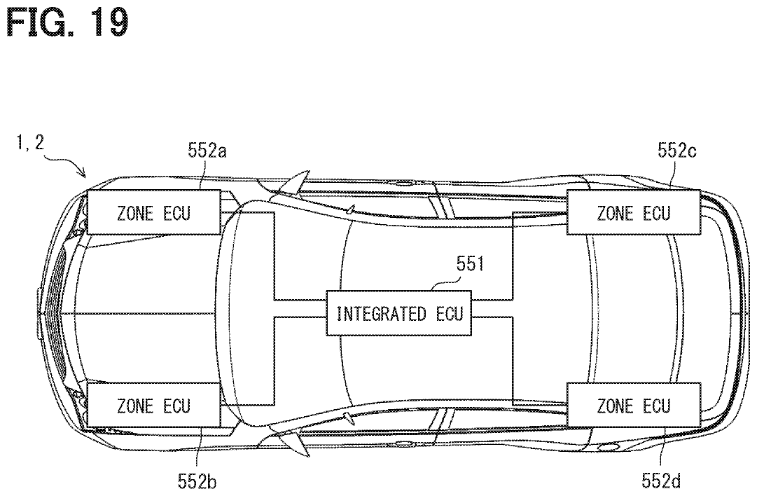

As another embodiment, the configuration of the processing system 50 may be a configuration as shown in FIGS. 18 and 19. For example, in FIG. 18, a configuration including multiple domain controllers 451 to 454 is adopted. Each of the domain controllers 451 to 454 may have the same hardware configuration as the processing system or the ECU of the first embodiment.

The ADAS domain controller 451 aggregates functionalities related to advanced driver-assistance systems (ADAS). The ADAS domain controller 451 may implement a part of the perception functionality, a part of the determination functionality, and a part of the control functionality in a combined manner. A part of the perception functionality implemented by the ADAS domain controller 451 may be, for example, a functionality corresponding to fusion of information sensed by the multiple sensors 40 in the sensing unit 10 of the first embodiment or a simplified functionality thereof. A part of the determination functionality implemented by the ADAS domain controller 451 may be, for example, a functionality corresponding to the prediction unit 21 and the driving planning unit 22 of the first embodiment or a simplified functionality thereof. A part of the control functionality implemented by the ADAS domain controller 451 may be, for example, a functionality of generating request information for the motion actuator 60 among the functionalities corresponding to the motion control unit 31 of the first embodiment.

The power train domain controller 452 aggregates functionalities related to control of a power train. The power train domain controller 452 may implement at least a part of the perception functionality and at least a part of the control functionality in a combined manner. A part of the perception functionality implemented by the power train domain controller 452 may be, for example, a functionality of perceiving an operating state of the driver for the motion actuator 60 among functionalities corresponding to the internal perception unit 13 of the first embodiment. A part of the control functionality implemented by the power train domain controller 452 may be, for example, a functionality of controlling the motion actuator 60 among the functionalities corresponding to the motion control unit 31 of the first embodiment.

The cockpit domain controller 453 aggregates functions related to cockpit. The cockpit domain controller 453 may implement at least a part of the perception functionality and at least a part of the control functionality in a combined manner. A part of the perception functionality implemented by the cockpit domain controller 453 may be, for example, a functionality of perceiving a switch state of the HMI device 70 in the internal perception unit 13 of the first embodiment. A part of the control functionality implemented by the cockpit domain controller 453 may be, for example, a functionality corresponding to the HMI output unit 71 of the first embodiment.

The connectivity domain controller 454 aggregates functionalities related to connectivity. The connectivity domain controller 454 may implement at least part of the perception functionality in a combined manner. A part of the perception functionality implemented by the connectivity domain controller 454 may be a functionality of organizing and converting global position data, V2X information, and the like of the ego-vehicle acquired from the communication system 43 in the form that can be used by, for example, the ADAS domain controller 451 and the cockpit domain controller 453.

In this embodiment, when software management is performed by each of the domain controllers 451 to 454 that implement each functionality, the multiple domain controllers 451 to 454 may correspond to “software management units” that form the management system MS or the test system.

In FIG. 19, a configuration including an integrated ECU 551 and multiple zones ECU 551a to ECU 551d is adopted. In this configuration, the multiple zones ECU 551a to ECU 551d execute control of devices, modules, units, apparatuses, and the like disposed in a predetermined assigned zone of the vehicle 1.

The external environment sensor 41 such as a camera disposed in the front of the vehicle 1 and the information presentation device 70b such as the CID 70b2 disposed in a cockpit are controlled by the zone ECU 551a or the zone ECU 551b disposed in the front of the vehicle 1. For example, the external environment sensor 41 such as a millimeter wave radar disposed on a rear side of the vehicle 1 is controlled by the zone ECU 551c or the zone ECU 551d disposed on the rear side of the vehicle 1.

The integrated ECU 551 aggregates the sensing information and the like from each of the zones ECU 551a to ECU 551d, and performs integrated control of the driving system 2 in each of the zones ECU 551a to ECU 551d. For example, the integrated ECU551 may implement substantially all of the planning functionality and the software management functionality.

As another embodiment, the vehicles 1, 1A, and 1B equipped with the driving systems 2, 2A, and 2B may be right-hand drive vehicles or left-hand drive vehicles. A traffic environment in which the vehicles 1, 1A, and 1B travel may be a traffic environment in which left-hand traffic is the norm or a traffic environment in which right-hand traffic is the norm. The driving systems 2, 2A, and 2B according to the present disclosure may be appropriately optimized in consideration of road traffic laws and customs across countries and regions, police investigations, prosecutions, criminal and civil lawsuits regarding traffic accidents, and the like.

The control unit and the method thereof described in the present disclosure may be implemented by a dedicated computer constituting a processor programmed to execute one or multiple functionalities embodied by a computer program. Alternatively, the device and the method thereof according to the present disclosure may be implemented by a dedicated hardware logic circuit. Alternatively, the device and the method thereof according to the present disclosure may be implemented by one or more dedicated computers implemented by a combination of a processor that executes a computer program and one or more hardware logic circuits. The computer program may be stored in a computer-readable non-transient tangible storage medium, as an instruction executed by a computer.

### DISCLOSURE OF TECHNICAL IDEAS

The present disclosure also includes technical ideas described below.

### Technical Idea 1

A vehicle software change device performs a software change in a test including a test of a notification mode in a vehicle. The vehicle software change device includes at least one processor with a memory storing computer program code. The at least one processor with the memory is configured to cause conventional software and test software to coexist in at least one storage medium in a switchable manner, and repeatedly switch between a notification based on the conventional software and a notification based on the test software during a conduction period of the test.

According to this technical idea, the vehicle user who evaluates the software can easily notice a point of change in the test software with respect to the conventional software. Therefore, the evaluation accuracy of the test software can be improved.

### Technical Idea 2

A vehicle software change device performs a process related to a software change including a change in a notification mode of a vehicle. The vehicle software change device includes at least one processor with a memory storing computer program code. The at least one processor with the memory is configured to specify the software change for changing the notification mode of a notification device mounted on the vehicle. The at least one processor with the memory is configured to set a change condition for the notification mode, and postpone a change timing of the notification mode when it is determined that the change condition for the notification mode is not satisfied.

According to this technical idea, the change is made again at the timing when the change condition is satisfied by the postponement, and therefore, the confusion of the vehicle user resulting from the software change can be reduced. In this way, the software change including the notification mode can be appropriately conducted.

### Technical Idea 3

In the vehicle software change device according to Technical Idea 2, the change condition for the notification mode is determined to be not satisfied in a state that is inappropriate for changing the notification mode, such as a state under a hazardous situation, a state during execution of a DDT fallback, or a state in which an occurrence state of authority transfer or a collision risk is higher than risk acceptance criteria/criterion.

### Technical Idea 4

A vehicle software change device performs a process related to a software change including a change in a notification mode of a vehicle. The vehicle software change device includes at least one processor with a memory storing computer program code. The at least one processor with the memory is configured to specify the software change for changing the notification mode of a notification device mounted on the vehicle. The at least one processor with the memory is configured to conduct the software change including the change in the notification mode so as to satisfy a change condition for the notification mode, and store information on the change condition in a storage medium.

According to this technical idea, it is easy to verify the state during occurrence of the trouble later by referring to the stored information on the change condition, when a trouble occurs in the vehicle 1 or the vehicle user due to the software change.

### Technical Idea 5

A method for generating data related to a software change including a change in a notification mode in a vehicle is provided. The method is performed by at least one processor by executing computer program code stored in a memory. The method includes specifying the software change for changing the notification mode of a notification device mounted on the vehicle. The method includes conducting the software change including the change in the notification mode so as to satisfy a change condition for the notification mode, and generating information on the change condition.

According to this technical idea, it is easy to verify the state during occurrence of the trouble later by referring to the generated information on the change condition, when a trouble occurs in the vehicle 1 or the vehicle user due to the software change.

What is claimed is:

1. A vehicle software change device, which performs a process related to a software change including a change of notification mode in a vehicle, the vehicle software change device comprising:
at least one processor with a memory storing computer program code, wherein the at least one processor with the memory is configured to:
specify the software change, which changes the notification mode in each of multiple notification devices mounted on the vehicle; and
conduct the software change by providing a time difference between a change timing of the notification mode in one of the multiple notification devices and a change timing of the notification mode in another one of the multiple notification devices.

2. The vehicle software change device according to claim 1, wherein the at least one processor with the memory is further configured to
define an order of the change timings of the notification modes in the multiple notification devices.

3. The vehicle software change device according to claim 1, wherein
the software change further includes a change of vehicle control mode in addition to the change of notification mode, and
in conducting of the software change, the at least one processor with the memory is configured to change the vehicle control mode after the change of the notification modes are completed in all of the multiple notification devices.

4. The vehicle software change device according to claim 1, wherein
the software change includes a change of display mode and a change of sound mode as the change of notification mode, and
in conducting of the software change, the at least one processor with the memory is configured to change the sound mode after the change of display mode is completed in all of the multiple notification devices.

5. The vehicle software change device according to claim 1, wherein,
in conducting of the software change, the at least one processor with the memory is configured to vary a change condition for the notification mode according to a type of the corresponding notification device.

6. The vehicle software change device according to claim 1, wherein,
in conducting of the software change, the at least one processor with the memory is configured to postpone the change timing of the notification mode in response to determining that a change condition for the notification mode is not satisfied.

7. The vehicle software change device according to claim 1, wherein
an automation level of the vehicle is configured to be switchable, and
in conducting of the software change, the at least one processor with the memory is configured to vary a change condition for the notification mode according to the automation level that is currently set.

8. The vehicle software change device according to claim 7, wherein,
in conducting of the software change, the at least one processor with the memory is configured to gradually increase a change amount of the notification mode at one change timing as a load of a driving task on a driver of the vehicle decreases.

9. The vehicle software change device according to claim 1, wherein
the software change includes start of a test, which includes a test of the notification mode in the vehicle.

10. The vehicle software change device according to claim 9, wherein the at least one processor with the memory is further configured to:
cause software before the change and software after the change to coexist in at least one storage medium in a switchable manner; and
during a conduction period of the test, repeatedly switch between a notification based on the software before the change and a notification based on the software after the change.

11. The vehicle software change device according to claim 10, wherein,
when the notification based on the software after the change is being conducted by the repeated switching, the at least one processor with the memory is configured to cause the corresponding notification device to execute a notification indicating that the notification currently conducted is the notification based on the software after the change.

12. The vehicle software change device according to claim 10, wherein,
in the repeated switching, the at least one processor with the memory is configured to set a switching timing corresponding to traveling control of the vehicle.

13. The vehicle software change device according to claim 9, wherein
the test further includes a test of vehicle control mode in addition to the test of notification mode, and
the at least one processor with the memory is further configured to alternately conduct the test of notification mode and the test of vehicle control mode.

14. The vehicle software change device according to claim 9, wherein
the test further includes a test of vehicle control mode in addition to the test of notification mode, and
the at least one processor with the memory is further configured to start one test among the test of notification mode and the test of vehicle control mode, and then start the remaining test after the one test is completed.

15. The vehicle software change device according to claim 1, wherein
the software change further includes a change of vehicle control mode in addition to the change of notification mode and the vehicle control mode is other than a mode related to traveling of the vehicle on an open road, and
in conducting of the software change, the at least one processor with the memory is configured to execute the change of vehicle control mode at the change timing of the notification mode in at least one of the multiple notification devices.

16. The vehicle software change device according to claim 1, wherein the at least one processor with the memory is further configured to:
request, after the software change is specified, consent to the software change from a driver of the vehicle while demonstrating the notification mode after the software change is conducted on the multiple notification devices; and
conduct, in response to the consent being obtained, the software change with the time difference.

17. The vehicle software change device according to claim 1, wherein
the vehicle software change device is communicably connected to a mobile terminal, and
the at least one processor with the memory is further configured to:
request, after the software change is specified, consent to the software change from a vehicle user while giving an advance notice of the software change on the mobile terminal; and
conduct, in response to the consent being obtained, the software change with the time difference.

18. The vehicle software change device according to claim 1, wherein the at least one processor with the memory is further configured to:
give an advance notice of the software change when an engine switch of the vehicle is turned from an on state to an off state; and
conduct the software change with the time difference when the engine switch is turned to the on state again.

19. A vehicle software change method, which is performed by at least one processor executing computer program code stored in a memory, the software change including a change of notification mode in a vehicle, the vehicle software change method comprising:
specifying the software change, which changes the notification mode in each of multiple notification devices mounted on the vehicle; and
conducting the software change by providing a time difference between a change timing of the notification mode in one of the multiple notification devices and a change timing of the notification mode in another one of the multiple notification devices.

20. A computer-readable non-transitory storage medium storing vehicle software change program for performing a process related to a software change including a change of notification mode in a vehicle, the vehicle software change program comprising instructions to be executed by at least one processor to execute:
specifying the software change, which changes the notification mode in each of multiple notification devices mounted on the vehicle; and
conducting the software change by providing a time difference between a change timing of the notification mode in one of the multiple notification devices and a change timing of the notification mode in another one of the multiple notification devices.
